(19) United States
(12) Patent Application Publication
(10) Pub. No.: US 2007/0233719 A1
(43) Pub. Date: Oct. 4, 2007

(54) Information providing method, information providing system, information providing apparatus, information receiving apparatus, and computer program product

(75) Inventors: Tomohiro Ikeda, Osaka (JP); Shuichi Enomoto, Osaka (JP); Takehiko Nagai, Osaka (JP); Hiroyuki Tanaka, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/495,553

(22) Filed: Jul. 31, 2006

(30) Foreign Application Priority Data
Mar. 31, 2006 (JP) 2006-099443

(51) Int. Cl. G06F 7/00

(52) U.S. Cl. 707/101

(57) ABSTRACT

A central apparatus capable of communicating with a plurality of terminal apparatuses through a relay apparatus transmits to the terminal apparatus a browsing program for browsing provision information. The terminal apparatus receiving the browsing program accepts a start instruction of the browsing program and transmits a start notice for notifying that the browsing program is started according to the accepted start instruction. The central apparatus reads the provision information from a database in response to the received start notice, and transmits the read provision information to the terminal apparatus. Thus, it is possible to provide information having high value added only in a transmitted place at the position, and there is no fear to force those who find no value added in the information to receive unnecessary information.

### CROSS-REFERENCE TO RELATED APPLICATIONS

This Nonprovisional application claims priority under 35 U.S.C. §119(a) on Patent Application No. 2006-99443 filed in Japan on Mar. 31, 2006, the entire contents of which are hereby incorporated by reference.

### BACKGROUND OF THE INVENTION

1. Field of the Invention

The present invention relates to an information providing method, an information providing system and an information providing apparatus which transmit provision information transmitted from a central apparatus to a plurality of terminal apparatuses through a relay apparatus, and more particularly to an information providing method, an information providing system and an information providing apparatus which can select whether to receive provision information or not by an information receiving apparatus (terminal apparatus). In addition, the present invention relates to a computer program product to implement such information providing apparatus with a general purpose computer, and to an information receiving apparatus (terminal apparatus) to which the provision information is provided.

2. Description of the Related Art

Conventionally, means for providing information has been such that the information is provided to a large-ranged general public by electric wave broadcasting. However, according to such electric wave broadcasting, information appropriate for a specific place cannot be provided to a limited specific place.

Thus, an information providing system which can provide at a specific point information having high value added only at a specific place to persons gathering at the specific place has been proposed (refer to Japanese Patent Application Laid-Open No. 2004-187249, for example).

An information providing system disclosed in Japanese Patent Application Laid-Open No. 2004-187249 comprises a transmitter and a receiver which receives information transmitted from the transmitter, in which the transmitter arranged in a specific region transmits the information and the transmitted information is received by the receiver owned by a person existing within a transmittable range around the specific region.

However, according to the system disclosed in Japanese Patent Application Laid-Open No. 2004-187249, since the information is uniformly provided to all the general public existing in the specific region, a person who does not find the value added in the information is forced to receive the waste information, while a person who wants to receive only necessary information in the information having value added cannot select the information.

### BRIEF SUMMARY OF THE INVENTION

The present invention is made in view of the above circumstances, and it is a main object of the present invention to provide an information providing method, an information providing system and an information providing apparatus in which an information provider can provide information having high value added only in the vicinity of a specific place while an information receiver in the vicinity of the specific place is not unilaterally forced to receive the information in which the receiver can find no value added. In addition, it is an object of the present invention to provide a computer program product and an information receiving apparatus for such information providing apparatus.

An information providing method according to the present invention to solve the above problems is an information providing method for providing provision information from a central apparatus to a terminal apparatus through a relay apparatus, the central apparatus being connected to a database in which provision information is registered and having a storage unit in which a browsing program for browsing the provision information is stored, and the terminal apparatus having a storage unit, and is characterized by comprising the steps of: by the central apparatus, reading the browsing program from the storage unit; by the central apparatus, transmitting the read browsing program to the relay apparatus; by the relay apparatus, transmitting the browsing program received from the central apparatus to the terminal apparatus; by the terminal apparatus, storing the browsing program received from the relay apparatus in the storage unit; by the terminal apparatus, accepting a start instruction of the browsing program stored in the storage unit; by the terminal apparatus, starting the browsing program stored in the storage unit according to the accepted start instruction; by the terminal apparatus, transmitting a start notice for notifying that the browsing program is started to the relay apparatus; by the relay apparatus, transmitting the start notice received from the terminal apparatus to the central apparatus; and by the central apparatus, when the start notice is received from the relay apparatus, extracting the provision information from the database in response to the start notice received from the relay apparatus and transmitting to the terminal apparatus through the relay apparatus.

An information providing system according to a first aspect of the present invention is characterized by including: a database in which provision information is registered; a central apparatus, having a storage unit in which a browsing program for browsing the provision information is stored, for transmitting the provision information extracted from the database; a relay apparatus, capable of communicating with the central apparatus and the terminal apparatus, for relaying the provision information received from the central apparatus to the terminal apparatus; and a terminal apparatus, capable of communicating with the relay apparatus, for receiving the provision information relayed by the relay apparatus; wherein the central apparatus comprises means for transmitting the browsing program read from the storage unit to the relay apparatus; the relay apparatus comprises means for transmitting the browsing program received from the central apparatus to the terminal apparatus, the terminal apparatus comprises: receiving means for receiving the browsing program from the relay apparatus; storing means for storing the received browsing program; means for accepting a start instruction of the browsing program stored in the storing means; means for staring the browsing program stored in the storing means according to the accepted start instruction; and notice transmitting means for transmitting a start notice for notifying that the browsing program is started to the relay apparatus; the relay apparatus transmits the start notice received from the terminal apparatus to the central apparatus, and the central apparatus, when the start notice is received from the relay apparatus, extracts the provision information from the database in response to the start notice received from the relay apparatus and transmits to the terminal apparatus through the relay apparatus.

The information providing system according to a second aspect of the present invention is, in the first aspect of the same, characterized in that a plurality of the relay apparatuses are provided, and relay apparatus identifying information for identifying each relay apparatus is assigned to each relay apparatus, a plurality of the terminal apparatuses are provided, and terminal identifying information for identifying each terminal apparatus is assigned to each terminal apparatus, a plurality of pieces of provision information are registered in the database so as to correspond to the relay apparatus identifying information for identifying each of the plurality of relay apparatuses, the each terminal apparatus transmits the start notice to the relay apparatus together with the terminal identifying information for identifying the each terminal apparatus, the each relay apparatus transmits the received start notice to the central apparatus together with the relay apparatus identifying information for identifying the each relay apparatus, and the central apparatus, when the start notice and the relay apparatus identifying information are received from the relay apparatus, extracts from the database provision information registered so as to correspond to the received relay apparatus identifying information in response to the received start notice, and transmits the extracted provision information to the relay apparatus identified by the received relay apparatus identifying information.

The information providing system according to a third aspect of the present invention is, in the second aspect of the same, characterized in that communication between the each relay apparatus and the each terminal apparatus is performed by wireless communication, the each relay apparatus further comprises means for transmitting a signal for detecting a signal intensity in the wireless communication to the terminal apparatus so as to correspond to the relay apparatus identifying information, the each terminal apparatus further comprises means for detecting an intensity of the received signal, and means for selecting a relay apparatus identified by the relay apparatus identifying information corresponding to a signal having a highest intensity among the detected intensities, and makes the notice transmitting means transmit the start notice to the selected relay apparatus.

The information providing system according to a fourth aspect of the present invention is, in the second or third aspect of the same, characterized in that the terminal apparatus comprises means for, by control of the browsing program, generating provision information specifying information for specifying the provision information to which specifying is accepted, when the terminal apparatus accepts specifying of one of the plurality of pieces of provision information, the notice transmitting means transmits the start notice to the relay apparatus together with the generated provision information specifying information, and the central apparatus extracts from the database provision information corresponding to the received relay apparatus identifying information and provision information specifying information in response to the received start notice, when the central apparatus receives the start notice, the provision information specifying information and the relay apparatus identifying information from the relay apparatus.

In addition, the information providing system according to the fifth aspect of the present invention is, in one of the second through fourth aspects of the same, characterized by further including a database in which the terminal identifying information for identifying the terminal apparatus having transmitted the start notice, the relay apparatus identifying information, and the position information regarding a position of the relay apparatus installed identified by the relay apparatus identifying information are correspondingly registered, wherein the terminal apparatus further comprises: means for, by control of the browsing program, generating a transmission request based on the accepted transmission instruction when a transmission instruction of the position information is accepted; means for receiving the terminal identifying information for identifying the terminal apparatus of which position information is to be searched and the transmission instruction of the position information; means for transmitting the generated transmission request and the accepted terminal identifying information to the central apparatus through the relay apparatus; and output means for, by control of the browsing program, outputting the received information; the central apparatus further comprises: means for extracting from the database the position information corresponding to the received terminal identifying information in response to the received transmission request; and means for transmitting the extracted position information to the terminal apparatus through the relay apparatus, wherein the terminal apparatus makes, by control of the browsing program, the output means output the received position information.

An information providing apparatus according to the present invention is an information providing apparatus which is connected to a database in which provision information and identifying information for identifying an external apparatus to which the provision information is to be transmitted are correspondingly registered, and transmits the provision information registered in the database to an external apparatus, and is characterized by comprising: a storage unit in which a browsing program for browsing the provision information is stored; means for reading the browsing program from the storage unit when the identifying information is received from an external apparatus; means for transmitting the read browsing program to the external apparatus identified by the received identifying information; means for, when from an external apparatus a start notice for notifying that the browsing program is started and identifying information for identifying the external apparatus are received, in response to the received start notice, extracting the provision information corresponding to the received identifying information from the database; and means for transmitting the extracted provision information to the external apparatus identified by the received identifying information.

An information receiving apparatus according to a first aspect of the present invention is an information receiving apparatus for receiving the provision information from an information providing apparatus, the information providing apparatus being connected to a database in which provision information is registered, and transmitting the provision information registered in the database and a browsing program for browsing the provision information to outside, and is characterized by comprising: storing means for storing the browsing program transmitted from the information providing apparatus; means for accepting a start instruction of the browsing program stored in the storing means; means for starting the browsing program stored in the storing means according to the accepted start instruction; notice transmitting means for transmitting to the information providing apparatus a start notice for notifying that the browsing program is started; means for receiving the provision information which is, by the information provision apparatus, extracted from the database and transmitted in response to a received start notice when the information providing apparatus receives the start notice; and outputting means for, by control of the browsing program, outputting the received provision information.

The information receiving apparatus according to a second aspect of the present invention is, in the first aspect of the same, characterized by further comprising: communicating means for communicating with the information providing apparatus by wireless communication through one of the plurality of relay apparatuses to which relay apparatus identifying information for identifying each relay apparatus is assigned; means for detecting an intensity of a signal received from each relay apparatus by wireless communication; and means for selecting the relay apparatus identified by the relay apparatus identifying information corresponding to a signal having a highest intensity among the detected intensities; wherein the communicating means communicates with the information providing apparatus through the selected relay apparatus.

The information receiving apparatus according to a third aspect of the present invention is, in the second aspect of the same, characterized by further comprising: means for accepting specifying of one of the plurality of pieces of provision information; and means for, by control of the browsing program, generating provision information specifying information for specifying the specified provision information to which specifying is accepted; wherein the notice transmitting means transmits the start notice to the information providing apparatus through the relay apparatus together with the generated provision information specifying information, the communicating means receives through the relay apparatus the provision information extracted from the database by the information providing apparatus, when the information providing apparatus receives the start notice, the provision information specifying information and the relay apparatus identifying information, in response to the received start notice, correspondingly to the received relay apparatus identifying information and the provision information specifying information, and the outputting means outputs the received provision information by control of the browsing program.

The information receiving apparatus according to a fourth aspect of the present invention is, in the second or third aspect of the same, characterized by further comprising: means for, by control of the browsing program, generating a transmission request, when a transmission instruction of the position information is accepted, based on the accepted transmission instruction; means for accepting the identifying information for identifying the external apparatus of which position information is to be searched and the transmission instruction of the position information; and means for transmitting the generated transmission request and the accepted identifying information to the information providing apparatus through the relay apparatus, wherein the communicating means receives the position information extracted by the information providing apparatus in response to the received transmission request, corresponding to the identifying information received by the information providing apparatus, from a data base correspondingly registering the identifying information for identifying the external apparatus having transmitted the start notice, the relay apparatus identifying information and the position information on a position of the relay apparatus installed identified by the relay apparatus identifying information, and the outputting means outputs the received position information by control of the browsing program.

A computer program product according to the present invention is a computer program product for controlling a computer connected to a database in which provision information and identifying information indicating an external apparatus to which the provision information is to be provided are correspondingly registered and having a storage unit in which a browsing program for browsing the provision information is stored, for transmitting the provision information registered in the database to outside, wherein the computer program product comprises: a computer readable storage medium having computer readable program code means embodied in the medium, and the computer readable program code means is characterized by comprising computer instruction means for: reading the browsing program from the storage unit; transmitting the read browsing program to outside; receiving from an external apparatus a start notice for notifying that the browsing program is started and identifying information for identifying the external apparatus; extracting from the database the provision information corresponding to the received identifying information in response to the received start notice; and transmitting the extracted provision information to the external apparatus identified by the received identifying information.

According to the above described present invention, the central apparatus transmits to the terminal apparatus a browsing program for browsing provision information. When the terminal apparatus which received the browsing program accepts a start instruction of the browsing program, it transmits a start notice notifying that the browsing program is started according to the accepted start instruction. The central apparatus reads out the provision information from a database in response to the received start notice and transmits the read provision information to the terminal apparatus. In addition, the central apparatus extracts from the database provision information corresponding to the relay apparatus identifying information for identifying the receiving relay apparatus and transmits the extracted provision information to the terminal apparatus which has transmitted the start notice through the relay apparatus identified by the relay apparatus identifying information. Therefore, a provider of the information can provide information having high value added only in the vicinity of the location of the relay apparatus.

According to the above-described present invention, a person who receives information in the vicinity of the location of the relay apparatus is not unilaterally forced to receive information in which the receiver can find no value added.

The above and further objects and features of the present invention will more fully be apparent from the following detailed description with accompanying drawings.

### BRIEF DESCRIPTION OF THE SEVERAL VIEWS OF THE DRAWINGS

FIG. 1 is a block diagram showing an example of an entire configuration and an inner configuration of each component of an information providing system according to the present invention;

FIG. 2 is one explanatory view showing an example of registered contents of a program management table stored in a database serving as one component of the information providing system according to the present invention;

FIG. 3 is an explanatory view showing one example of registered contents of a member information table stored in the database serving as one component of the information providing system according to the present invention;

FIG. 4 is an explanatory view showing one example of registered contents of an information management table stored in the database serving as one component of the information providing system according to the present invention;

FIG. 5 is an explanatory view showing one example of registered contents of a communication table stored in the database serving as one component of the information providing system according to the present invention;

FIG. 6 is an explanatory view showing one example of registered contents of a relay table stored in the database serving as one component of the information providing system according to the present invention;

FIG. 7A to FIG. 7H are flowcharts showing procedure executed by the information providing system according to Embodiment 1 of the present invention;

FIG. 8 is a schematic view showing an example of a display screen of provision information in a browsing program executed by a terminal apparatus serving as one component of the information providing system according to the present invention;

FIG. 9 is a flowchart showing a procedure in a terminal apparatus of the information providing system according to Embodiment 2 of the present invention;

FIG. 10A to FIG. 10D are flowcharts showing procedures of the information providing system according to Embodiment 3 of the present invention;

FIG. 11 is a schematic view showing a display example of a screen for receiving terminal identifying information by the browsing program executed by the terminal apparatus serving as one component of the information providing system according to the present invention; and

FIG. 12 is a schematic view showing a display example of a screen for displaying position information by the browsing program executed by the terminal apparatus serving as one component of the information providing system according to the present invention.

### DETAILED DESCRIPTION OF THE PRESENT INVENTION

The present invention will be described hereinafter with reference to drawings showing Embodiments thereof. Although several Embodiments will be described hereinafter, a system configuration of a information providing system according to the present invention will firstly be described and several different procedures will then be described respectively as individual Embodiments since the system configuration is common in general.

According to the following description, it will be made of a case where each department in a shopping center is provided as a specific place in the present invention.

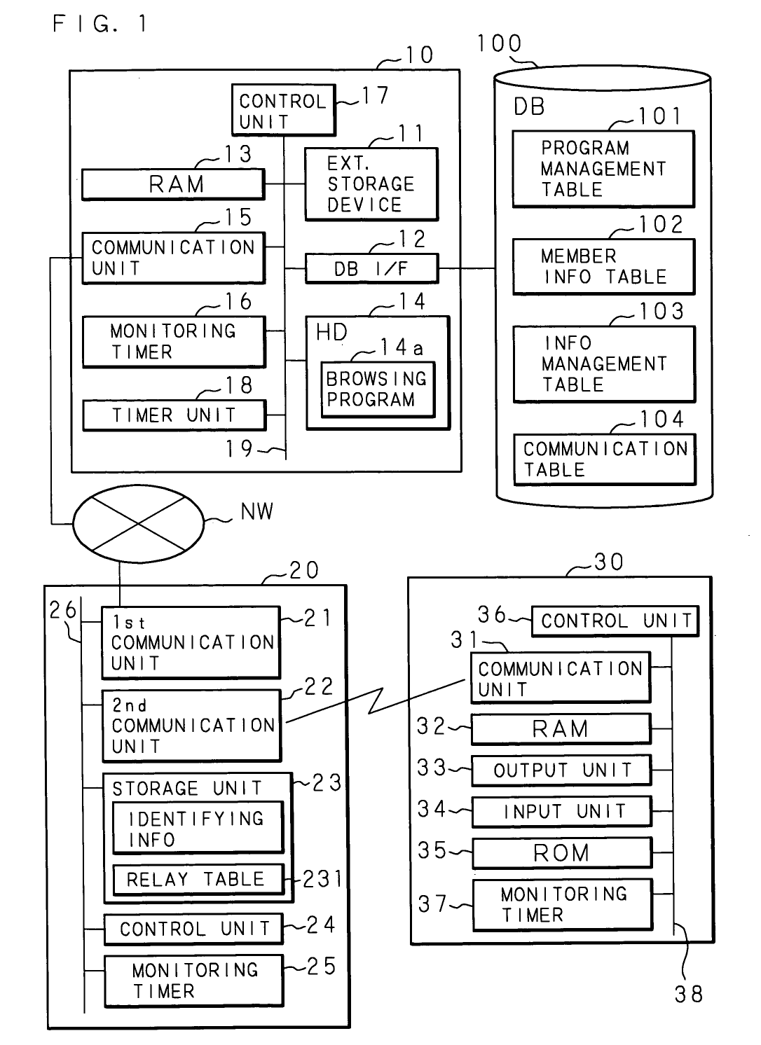

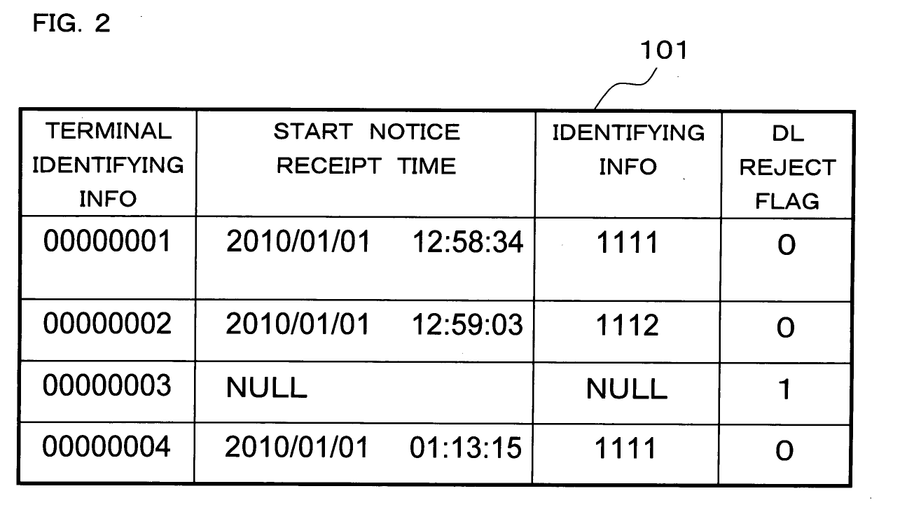

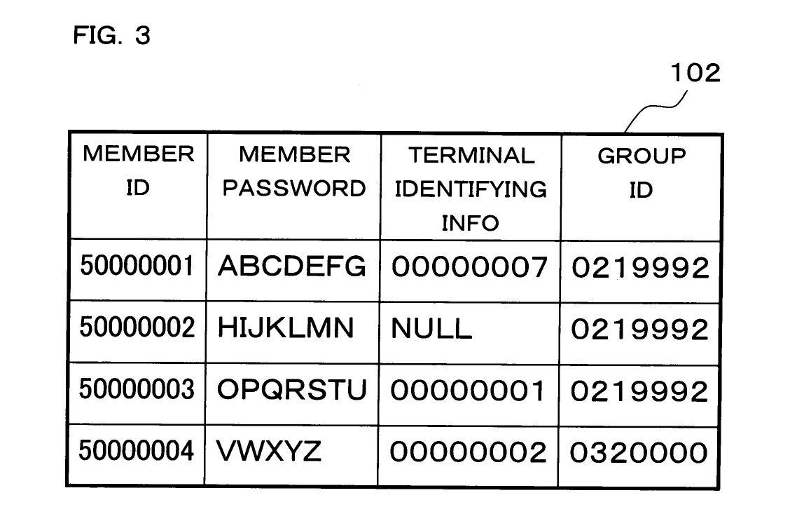

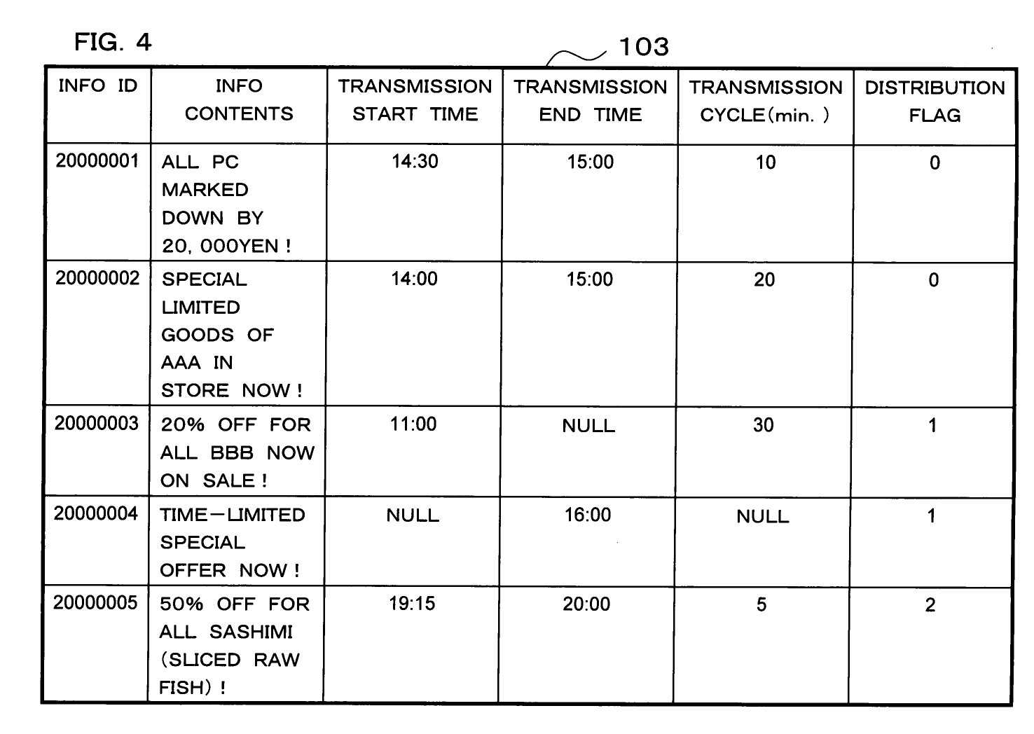

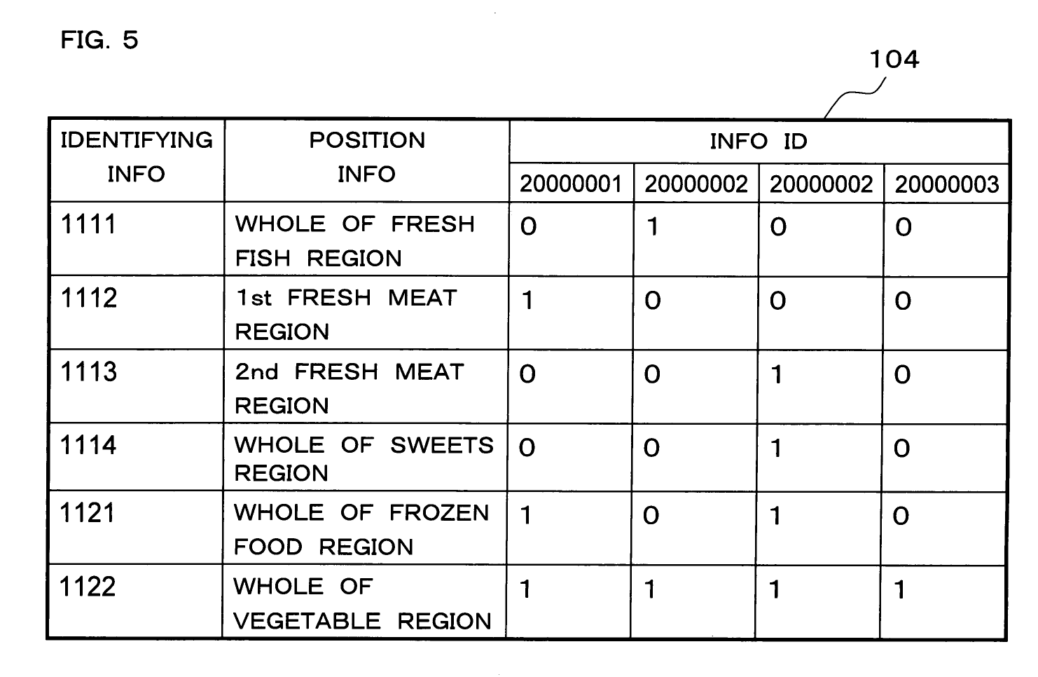

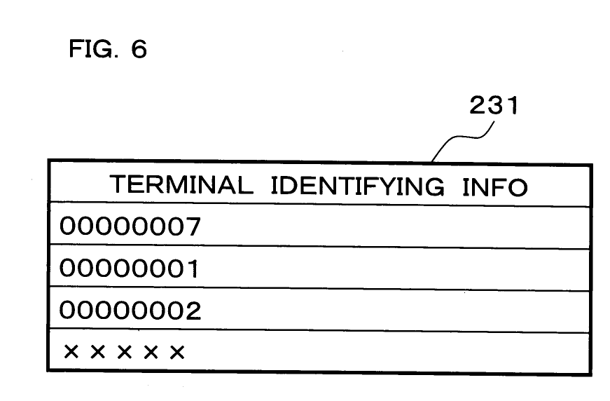

FIG. 1 is a block diagram showing an example of an entire configuration and an inner configuration of each component of an information providing system according to the present invention. FIG. 2 is an explanatory view showing one example of registered contents of a program management table stored in a database serving as one component of the information providing system according to the present invention. FIG. 3 is an explanatory view showing one example of registered contents of a member information table stored in the database serving as one component of the information providing system according to the present invention. FIG. 4 is an explanatory view showing one example of registered contents of an information management table stored in the database serving as one component of the information providing system according to the present invention. FIG. 5 is an explanatory view showing one example of registered contents of a communication table stored in the database serving as one component of the information providing system according to the present invention. FIG. 6 is an explanatory view showing one example of registered contents of a relay table stored in the database serving as one component of the information providing system according to the present invention.

In FIG. 1, reference numeral 10 denotes a central apparatus serving as one component of the information providing system according to the present invention, which can be realized by a server computer and the like. The central apparatus 10 is managed by a business entity who provides the information providing system according to the present invention. The central apparatus 10 is connected with a plurality of relay apparatuses 20 (only one being illustrated in FIG. 1) through a network NW such as the Internet or intranet. Each relay apparatus 20 can intercommunicate with a plurality of terminal apparatuses 30 positioned within a communicable range thereof through wireless communication or the like. When the relay apparatus 20 detects a terminal apparatus 30, the central apparatus 10 transmits through the network NW to the relay apparatus 20 data for displaying a confirmation notice to confirm whether a browsing program 14a for browsing provision information by the terminal apparatus 30 is to be downloaded or not (hereinafter above mentioned data is referred to as confirmation notice display data).

Each relay apparatus 20 can communicate with the central apparatus 10 through the network NW and transmits the confirmation notice display data received from the central apparatus 10 to the terminal apparatus 30.

The terminal apparatus 30 is a portable type terminal apparatus such as a mobile phone or a PDA (Personal Digital Assistants). Each terminal apparatus 30 can communicate with the relay apparatus 20 through wireless communication such as an electric wave, an infrared ray or a laser. For example, when the terminal apparatus 30 enters a communicable region of the relay apparatus 20, the terminal apparatus 30 receives confirmation notice display data from the relay apparatus 20 and outputs a confirmation notice as an image for example, based on the received confirmation notice display data. Upon accepting a response to the confirmation notice from a user, the terminal apparatus 30 transmits the accepted response to the central apparatus 10 through the relay apparatus 20. Note that a plurality of terminal apparatuses 30 can be connected to each relay apparatus 20.

The central apparatus 10 transmits the browsing program 14a to the terminal apparatus 30 through the relay apparatus 20 in response to the response received through the relay apparatus 20.

When the terminal apparatus 30 accepts from the user a start instruction of the received browsing program 14a, it starts the browsing program 14a according to the received start instruction. When the browsing program 14a is started, the terminal apparatus 30 transmits a start notice for notifying that the browsing program 14a is started to the relay apparatus 20. After the browsing program 14a is started, the start notice continuously transmitted at intervals of one second, for example, from the terminal apparatus.

The relay apparatus 20 transmits the received start notice to the central apparatus 10 together with relay apparatus identifying information for identifying itself.

The central apparatus 10 accesses a database (DB) 100 in response to the start notice received from the relay apparatus 20 so as to extract provision information registered in the database 100. The central apparatus 10 transmits the provision information extracted from the database 100 to the terminal apparatus 30 through the relay apparatus 20 identified by the previously received relay apparatus identifying information. The terminal apparatus 30 outputs (displays) the received provision information as an image, for example.

As described above, the central apparatus 10 constantly transmits the confirmation notice display data for confirming whether to receive the browsing program or not. Meanwhile, the user of the terminal apparatus 30 entering the communicable range of the relay apparatus 20 responds to the confirmation notice so as to select whether to receive the browsing program or not. Furthermore, even when the user receives the browsing program, the user can select whether to receive the provision information or not by selecting whether to start the browsing program or not. Therefore, the user of the terminal apparatus 30 is not unilaterally forced to receive the provision information in which the user can find no value added.

The central apparatus 10 comprises an external storage device 11. The external storage device 11 is configured by a CD-ROM drive, a flexible disk drive or the like, which can read a computer program according to the present invention from a portable storage medium such as a CD-ROM, a flexible disk or the like in which the computer program is stored.

The central apparatus 10 comprises a database interface (DB I/F) 12 connected to the database 100. The central apparatus 10 accesses a program management table 101, a member information table 102, an information management table 103 and a communication table 104 stored in the database 100 through the database interface 12 so as to extract various data respectively registered therein. Thus extracted data is sent to a RAM 13 and temporarily stored therein, and then sent to the program management table 101 or the like.

The program management table 101 of which one example of registered contents is shown in FIG. 2 is a table for managing a start of the browsing program 14a, and consists of a plurality of records having a plurality of items of data. Data of terminal identifying information, a start notice receipt time, relay apparatus identifying information and a DL reject flag are registered in respective items in the program management table 101.

As the terminal identifying information, peculiar information such as a model type or manufacturing number which is for example assigned to the terminal apparatus 30 at the time of manufacturing is used. The terminal identifying information is transmitted from the terminal apparatus 30 to the central apparatus 10 through the relay apparatus 20 positioned within the communicable range and is registered in the program management table 101. Therefore, although the terminal identifying information of the terminal apparatus 30 entering the communicable range of the relay apparatus 20 is registered in the program management table 101, the terminal identifying information of the terminal apparatus which is located out of the communicable range is not registered therein.

The start notice receipt time is a time when the central apparatus 10 receives a start notice from the terminal apparatus 30 through the relay apparatus 20. More specifically, the start notice receipt time includes data showing dominical year, month, date, hour, minute and second, and is registered based on a time subject to clocking by a timer unit 18 described below.

The relay apparatus identifying information is a peculiar number assigned to each relay apparatus 20, and is transmitted from the relay apparatus 20 to the central apparatus 10 together with the start notice. The transmitted relay apparatus identifying information is received by the central apparatus 10 and is registered corresponding to the previously received terminal identifying information, that is, in a same record.

The DL (Down Load) reject flag is a flag showing whether the terminal apparatus 30 rejects download of the browsing program 14a or not. When a registered value of the DL reject flag is “1”, the central apparatus 10 regards that the download of the browsing program 14a is rejected and does not transmit confirmation notice display data or the browsing program 14a even when the relay apparatus 20 detects a corresponding terminal apparatus 30. Meanwhile, when the relay apparatus 20 does not detect such a terminal apparatus 30, that is, when the terminal apparatus 30 positions out of the communicable range of the relay apparatus 20, a corresponding record is deleted from the program management table 101.

For example, the start notice receipt time and the relay apparatus identifying information of the terminal apparatus 30 to which the terminal identifying information “00000003” which rejects the download of the browsing program 14a is assigned are NULL. In this case, after a predetermined waiting time is clocked by the timer unit 18 described below, the corresponding record is automatically deleted.

The member information table 102 of which one example of registered contents is shown in FIG. 3 is a table for managing the members of the information providing system according to the present invention, and consists of records having a plurality of items of data. Data on a member ID, a member password, a terminal identifying information and a group ID are registered in respective items of the member information table 102.

The member ID and the member password are information for identifying a registered user among the users of the terminal apparatus 30, and are registered through the terminal apparatus 30 operated by the user when the user uses the information providing system according to the present invention.

The terminal identifying information is transmitted from the terminal apparatus 30 to the central apparatus 10 through the relay apparatus 20 and is registered therein when the member is authenticated. Meanwhile, the terminal identifying information is updated to NULL when the terminal identifying information of the program management table 101 is deleted.

The group ID is information for associating an D and password of one certain member to those of another member. The group ID is registered through the terminal apparatus 30 operated by the user so as to correspond to the member ID and the member password when the information providing system according to the present invention is used. When one user is registered by specifying a same group ID as that of another user who is a family member or a friend of the user, these users are associated with each other on the table.

For example, in the member information table 102, the users assigned the member IDs “50000001” and “50000003” to which the same group ID “0219992” is assigned are managed as the same group members. In the member information table 102, the user assigned the member ID “50000002” whose terminal identifying information is NULL is managed such that the user is out of the communicable range of the relay apparatus 20.

The information management table 103 of which one example of registered contents is shown in FIG. 4 is a table for registering and managing provision information provided by the information providing system according to the present invention, and consists of records having a plurality of items of data. Data on an information ID for specifying a record, an information content, a transmission start time, a transmission end time, a transmission cycle, and a distribution flag is registered in the respective items of the information management table 103.

The information ID is information for identifying provision information transmitted to the terminal apparatus 30, and is assigned when the content of the provision information is registered.

The information content is provision information itself transmitted to the terminal apparatus 30, and more specifically, character information and/or image information and/or the like to be displayed in the terminal apparatus 30. Such an information content of the provision information is registered or updated by a business entity who provides the information providing system of the information providing system according to the present invention or the client who provides information.

The transmission start time is a time to have the central apparatus 10 start transmission of the provision information, and is registered or updated together with the provision information by the business entity who provides the information providing system or the client who provides the information. When the time clocked by the timer unit 18 described below reaches the transmission start time, a time-up notice is sent to a control unit 17. Upon receipt of the time-up notice, the control unit 17 starts transmission of the provision information. When a value of the transmission start time is NULL, the control unit 17 transmits the provision information to each terminal apparatus 30 at the transmission end time only one time.

The transmission end time is a time to have the central apparatus 10 terminate transmission of the provision information, and is registered or updated together with the provision information by the business entity who provides the information providing system or the client who provides the information. When the time clocked by the timer unit 18 described below reaches the transmission end time, a time-up notice is sent to the control unit 17. Upon receipt of the time-up notice, the control unit 17 terminates transmission of the provision information. When a value of the transmission end time is NULL, the control unit 17 transmits the provision information from the transmission start time to the end of the day (however, the transmission end time in this case is a closing time of a store in which the system according to the present invention is installed, for example).

The transmission cycle is a cycle showing a time interval (by minute) for having the central apparatus 10 retransmit the provision information, which is registered or updated when the provision information is registered or updated by the business entity who provides the information providing system or the client who provides the information. Every time the time clocked by the timer unit 18 described below reaches a transmission time determined by the transmission cycle, a time-up notice is transmitted to the control unit 17. Upon receipt of the time-up notice, the control unit 17 retransmits the provision information.

The distribution flag is information for specifying a condition of transmission of the provision information, and is registered or updated together with the provision information by the business entity who provides the information providing system or the client who provides the information. For example, when the value of the distribution flag is “0”, the control unit 17 does not transmit the provision information. When the value of the distribution flag is “1”, the control unit 17 transmits the provision information without any condition. When the value of the distribution flag is “2”, the control unit 17 authenticates the member and transmits the provision information only to the terminal apparatus 30 operated by the user who is registered in the member information table 102.

For example, according to the example of the information management table 103 shown in FIG. 4, the provision information assigned the information IDs “20000001” and “20000002” to which the distribution flag “0” is registered is not transmitted. The provision information assigned the information IDs “20000003” and “20000004” to which the distribution flag “1” is registered is transmitted without any condition. The provision information assigned the information ID “20000005” to which the distribution flag “2” is registered is transmitted only to the terminal apparatus 30 operated by the member (authenticated member). The provision information assigned the information ID “20000003” is transmitted from 11:00 until the end of the day at intervals of 30 minutes. The provision information assigned the information ID “20000004” is transmitted only one time at 16:00. The provision information assigned the information ID “20000005” is transmitted from 19:15 to 20:00 at intervals of 5 minutes only to the terminal apparatus 30 operated by the member.

The communication table 104 of which one example of registered contents is shown in FIG. 5 is a table for managing the relay apparatus 20 for transmitting the provision information, and consists of records having a plurality of items of data. Data on position information and an information ID are registered in a record assigned to each relay apparatus identifying information in the communication table 104.

The position information is information showing a location in which each relay apparatus 20 is installed. More specifically, the position information is represented by map information showing the location where the relay apparatus 20 is installed.

The information ID corresponds to the information ID in the information management table 103, to which a value of “0” or “1” is respectively registered. For example, the control unit 17 does not transmit the provision information when the value of the information ID is “0”, and transmits the provision information when the value thereof is “1”.

According to an example of the communication table 104 shown in FIG. 5, the provision information assigned the information ID “20000002” is transmitted to the relay apparatus 20 assigned the relay apparatus identifying information “1111” and installed in a “whole of fresh fish region”. The provision information assigned the information ID “20000001” is transmitted to the relay apparatus 20 assigned the relay apparatus identifying information “1112” and installed in a “first fresh meat region”.

The central apparatus 10 comprises a RAM 13. The RAM 13 temporarily stores data extracted from the program management table 101 and the like and various kinds of computer programs including the browsing program 14a read from a hard disk (HD) 14.

The hard disk 14 stores the browsing program 14a, data for outputting (displaying) the confirmation notice from the terminal apparatus 30, and a computer program for controlling the central apparatus 10. The program stored in the hard disk 14 is read out to the RAM 13 according to need.

The central apparatus 10 comprises a communication unit 15 which is an interface connected to the network NW. The communication unit 15 transmits the data stored in the RAM 13, the provision information or the browsing program 14a or the like to the relay apparatus 20 through the connected network NW. Meanwhile, the communication unit 15 receives from the relay apparatus 20 the terminal identifying information, the response to the confirmation notice, the start notice, the relay apparatus identifying information, the member ID, the member password, the group ID, provision information specifying information for specifying provision information or the like and transmits to the RAM 13 to be temporarily stored therein. A monitoring timer 16 monitors a response time from an external transmission to a reception of a response thereto, and transmits a time-up notice to the control unit 17 upon clocking that a predetermined time passes without receiving a response.

The control unit 17 of the central apparatus 10 constantly transmits confirmation notice display data through the communication unit 15. The control unit 17 reads the browsing program 14a from the hard disk 14 in response to the response to the transmitted confirmation notice including the terminal identifying information from the relay apparatus 20, and transmits the same through the communication unit 15. Thus, the control unit 17 reads the information ID corresponding to the relay apparatus identifying information from the communication table 104 in response to the start notice transmitted from the terminal apparatus 30 when the browsing program 14a transmitted from the central apparatus 10 is started in the terminal apparatus 30. The control unit 17 reads the provision information assigned such read information ID from the information management table 103 and transmits the read provision information to the relay apparatus 20 identified by the relay apparatus identifying information through the communication unit 15.

Upon receipt of the time-up notice from the monitoring timer 16, the control unit 17 terminates the communication through the communication unit 15.

The timer unit 18 registers a time of receiving start notice to a start notice receipt time in the program management table 101. When the time clocked by the timer unit 18 reaches the transmission start time and the transmission end time registered in the information management table 103, the timer unit 18 transmits a time-up notice to the control unit 17. Furthermore, when the time clocked by the timer unit 18 reaches the time determined by the transmission cycle registered in the information management table 103, the timer unit 18 transmits the time-up notice to the control unit 17.

The external memory apparatus 11, the database interface 12, the RAM 13, the hard disk 14, the communication unit 15, the monitoring timer 16, the timer unit 18 provided in the central apparatus 10 are controlled by the control unit 17 through a bus 19.

A plurality of relay apparatuses 20 are connected to the central apparatus 10 as described above, and each relay apparatus 20 has a same configuration.

The relay apparatus 20 comprises a first communication unit 21 serving as an interface connected to the network NW. The first communication unit 21 communicates with the central apparatus 10 through the connected network NW. A response time from an external transmission by the first communication unit 21 to a reception of a response thereto is monitored by a monitoring timer 25 described below. When the clocked time reaches a predetermined time without receiving a response, the monitoring timer 25 transmits a time-up notice to a control unit 24.

The relay apparatus 20 further comprises a second communication unit 22 serving as an interface for wireless communication by an electric wave, an infrared ray or a laser of which communicable range is limited. Therefore, the second communication unit 22, in other words, the relay apparatus 20 can communicate only with the terminal apparatus 30 which enters the communicable range. A response time from an external transmission by the second communication unit 22 to a reception of a response thereto is monitored by the monitoring timer 25. When the clocked time reaches a predetermined time without receiving a response, the monitoring timer 25 transmits a time-up notice to the control unit 24.

The relay apparatus 20 comprises a storage unit 23 for storing the relay apparatus identifying information and a relay table 231.

The relay apparatus identifying information is peculiar information assigned to each relay apparatus 20 such as a number, for identifying each relay apparatus 20.

The relay table 231 of which one example of registered contents is shown in FIG. 6 is a table for managing the terminal apparatus 30 which can communicate through the second communication unit 22. In the relay table 231, the terminal identifying information transmitted from the terminal apparatus 30 being in the communicable state by entering the communicable range of the second communication unit 22, and received by the second communication unit 22 is registered. Therefore, the terminal identifying information of the terminal apparatus 30 positioned out of the communicable range of the second communication unit 22 is not registered in the relay table 231.

For example, the relay apparatus 20 having the relay table 231 shown in FIG. 6 manages the terminal apparatuses 30 assigned the terminal identifying information “00000007”, “00000001” and “00000002” as being in the communicable state, and manages the terminal apparatuses 30 registered no terminal identifying information as being out of the communicable range.

The relay apparatus 20 comprises a control unit 24. The control unit 24 receives the confirmation notice display data, the browsing program 14a, the provision information or the like transmitted from the central apparatus 10 through the first communication unit 21 and transmits the same to the terminal apparatus 30 registered in the relay table 231 through the second communication unit 22. Meanwhile, the control unit 24 receives the terminal identifying information, the response to the confirmation notice, the start notice, the member ID, the member password, the group ID, the provision information specifying information for specifying the provision information, and the like, transmitted from the terminal apparatus 30 through the second communication unit 22 and transmits the same together with the relay apparatus identifying information for identifying the relay apparatus 20 in which the control unit 24 itself is installed to the central apparatus 10 through the first communication unit 21.

Upon receipt of the time-up notice from the monitoring timer 25, the control unit 24 terminates the communication by the first communication unit 21 or the second communication unit 22.

Furthermore, the control unit 24 generates a signal intensity detecting signal for detecting signal intensity of the wireless communication between the second communication unit 22 and each terminal apparatus 30.

The first communication unit 21, the second communication unit 22, the storage unit 23 and the monitoring timer 25 provided in the relay apparatus 20 are controlled by the control unit 24 through a bus 26.

The terminal apparatus 30 comprises a communication unit 31 serving as an interface for wireless communication by such as an electric wave, an infrared ray or a laser of which communicable range is limited. The communication unit 31 can communicate with all the relay apparatuses 20 located within the communicable range. The communication unit 31 sends information including the browsing program 14a received from the relay apparatus 20 to a RAM 32, and transmits information stored in the RAM 32 to the relay apparatus 20. A predetermined response time from an external transmission by the communication unit 31 to a reception of a response thereto is monitored by a monitoring timer 37 described below. When the time clocked by the monitoring timer 37 reaches a predetermined time without receiving a response, the monitoring timer 37 transmits a time-up notice to the control unit 36.

The RAM 32 temporarily stores the browsing program 14a and various kinds of information received from the relay apparatus 20 through the communication unit 31. The information temporarily stored in the RAM 32 is sent to an output unit 33. Meanwhile, the RAM 32 temporarily stores information including a start instruction of the browsing program 14a received through an input unit 34, the terminal identifying information read from a ROM 35, and the like. The information temporarily stored in the RAM 32 is sent to the communication unit 31.

The output unit 33 is a device for outputting an image and/or a sound such as a liquid crystal panel and/or a speaker. The information stored in the RAM 32 is sent to the output unit 33 to be outputted as an image and/or sound.

The input unit 34 comprises various keys, buttons and the like. The input unit 34 accepts information on the response to the confirmation notice, the start instruction of the browsing program 14a, the member ID, the member password, the group ID, the provision information specifying information for specifying the provision information and the like inputted by the user of the terminal apparatus 30 by operating above mentioned various keys and buttons, and sends the same to the RAM 32.

The ROM 35 stores the terminal identifying information, a control program of the terminal apparatus 30 and the like. The information stored in the ROM 35 is read by the control unit 36 and is sent to the RAM 32.

The control unit 36 receives the confirmation notice display data through the communication unit 31 and sends to the output unit 33 through the RAM 32. Further, the control unit 36 sends the response to the confirmation notice displayed based on the confirmation notice display data accepted by the input unit 34 and temporarily stored in the RAM 32 from the RAM 32 to the communication unit 31.

Furthermore, the control unit 36 receives the browsing program 14a through the communication unit 31 and stores in the RAM 32, and makes the output unit 33 output information for informing the user that the browsing program 14a can be started. The control unit 36 starts the browsing program 14a in response to the start instruction received by the input unit 34, and generates the start notice for notifying that the browsing program 14a is started to be temporarily stored in the RAM 32. The start notice temporarily stored in the RAM 32 is transmitted to the relay apparatus 20 through the communication unit 31.

Upon receipt of the time-up notice from the monitoring time 37, the control unit 36 terminates the communication by the communication unit 31.

Furthermore, the control unit 36 receives through the communication unit 31 the signal intensity detecting signals respectively transmitted from a plurality of relay apparatuses 20. Then, the control unit 36 detects the intensities of the received signal intensity detecting signals and selects the signal intensity detecting signal (more specifically, the relay apparatus 20 which transmitted the signal intensity detecting signal) having a highest intensity among the detected intensities.

The communication unit 31, the RAM 32, the output unit 33, the input unit 34, the ROM 35 and the monitoring timer 37 provided in the terminal apparatus 30 are controlled by the control unit 36 through a bus 38.

Several Embodiments regarding an operation example of the information providing system having the above-described system configuration according to the present invention will be described hereinafter.

### Embodiment 1

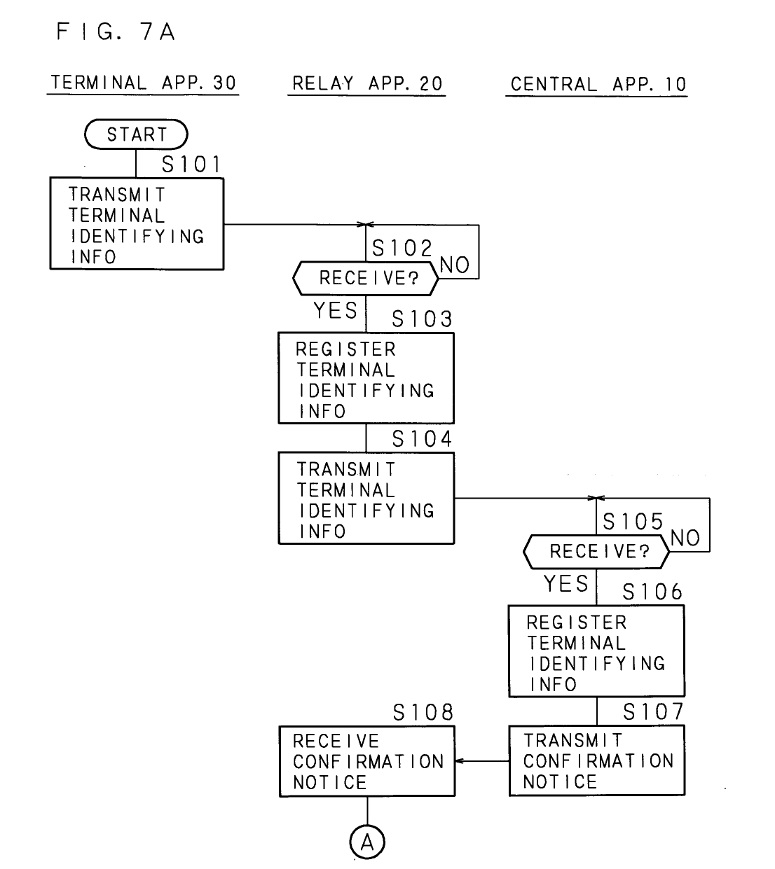

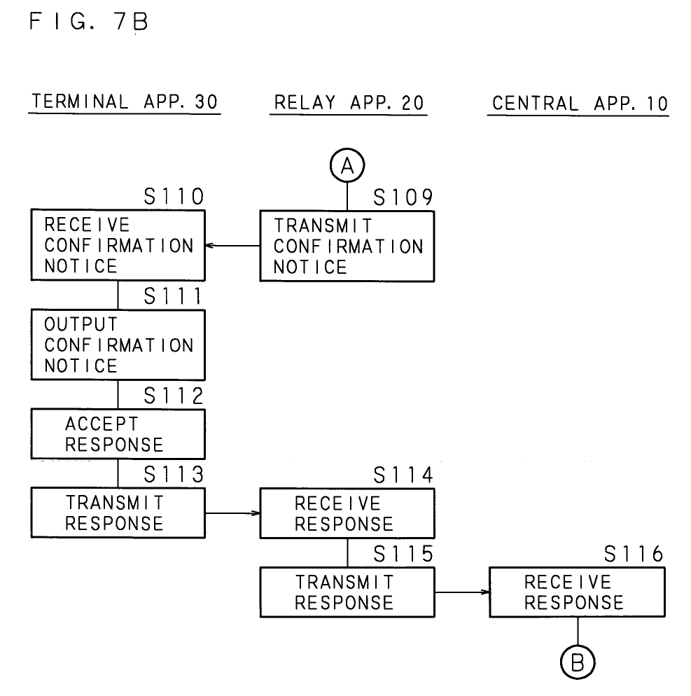

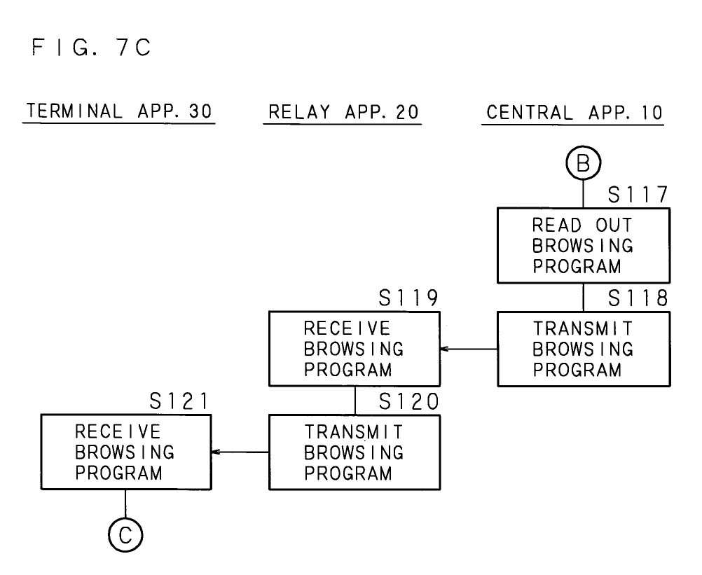

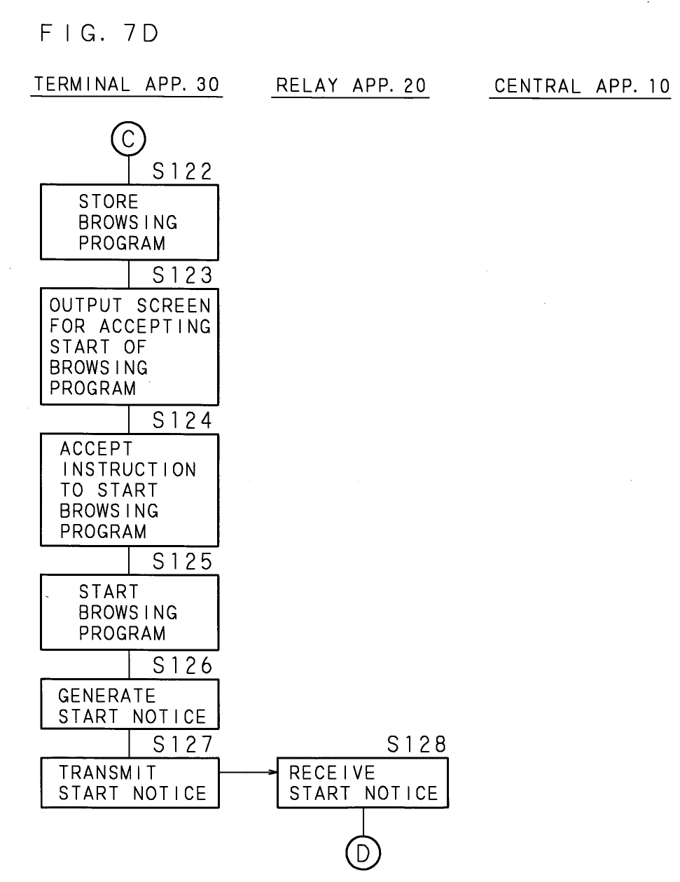

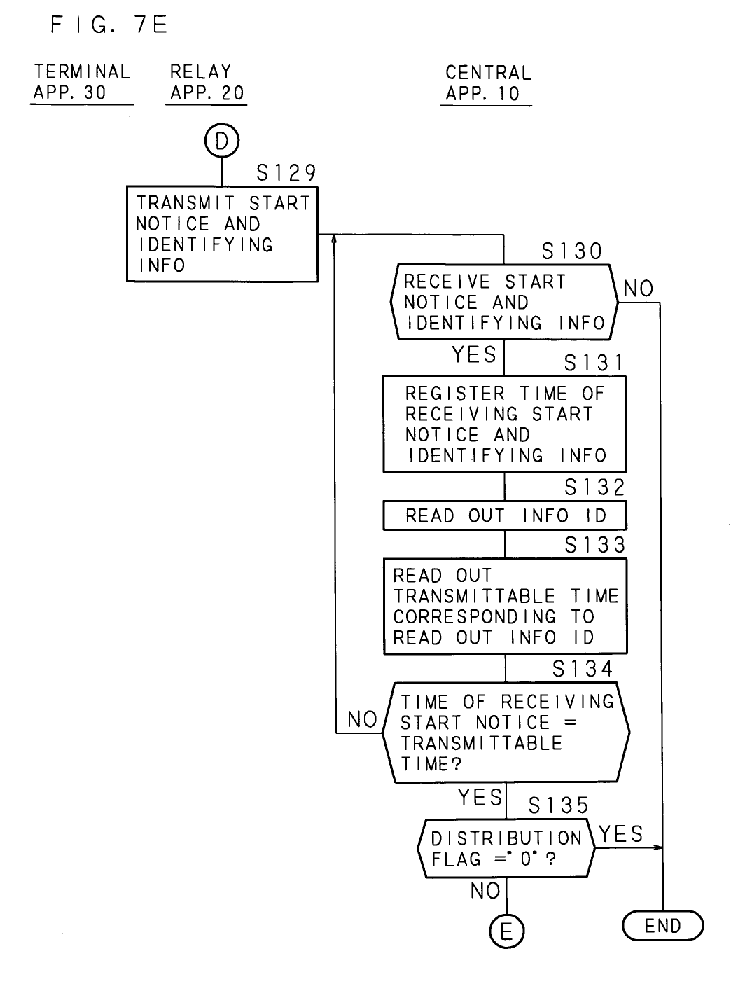

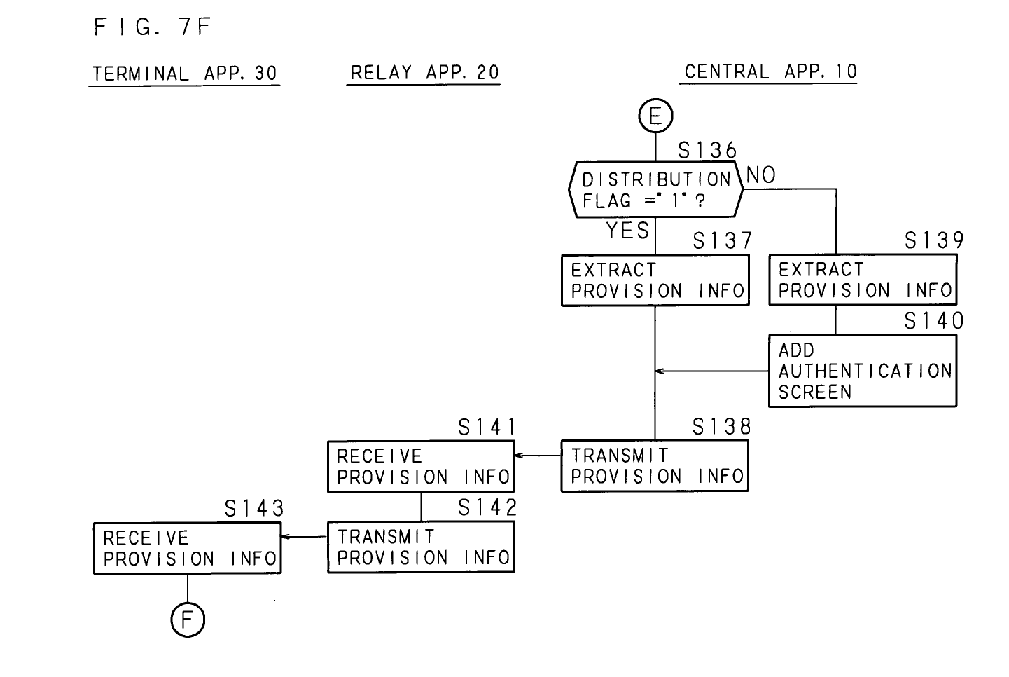

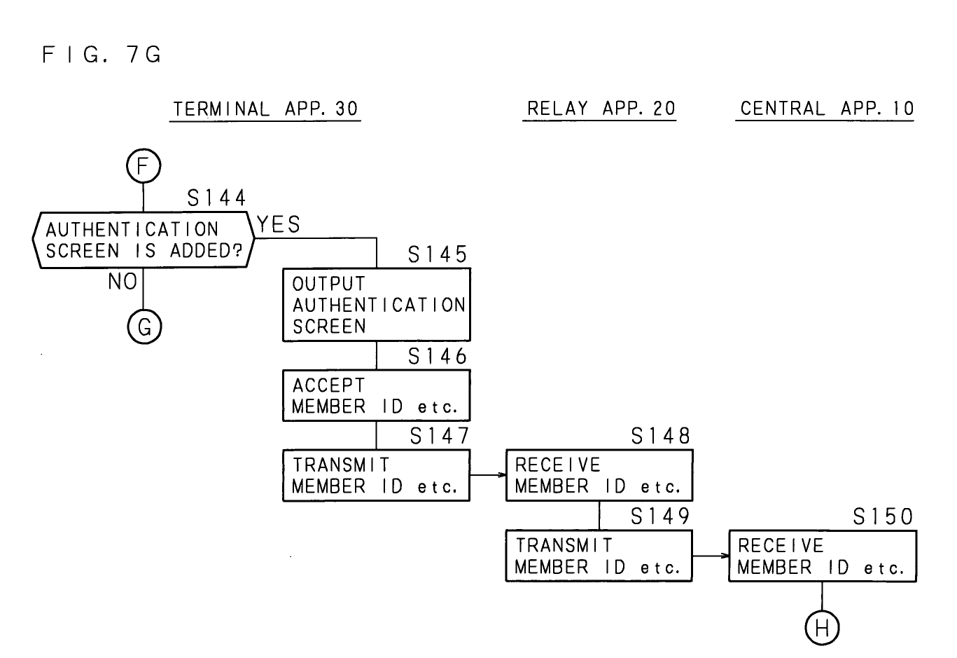

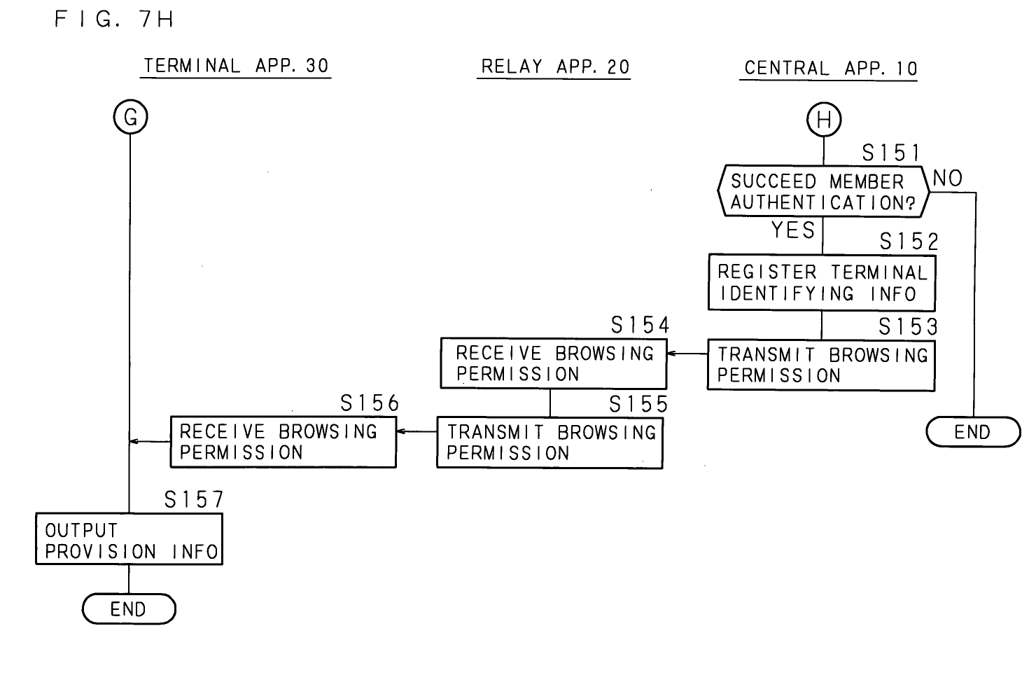

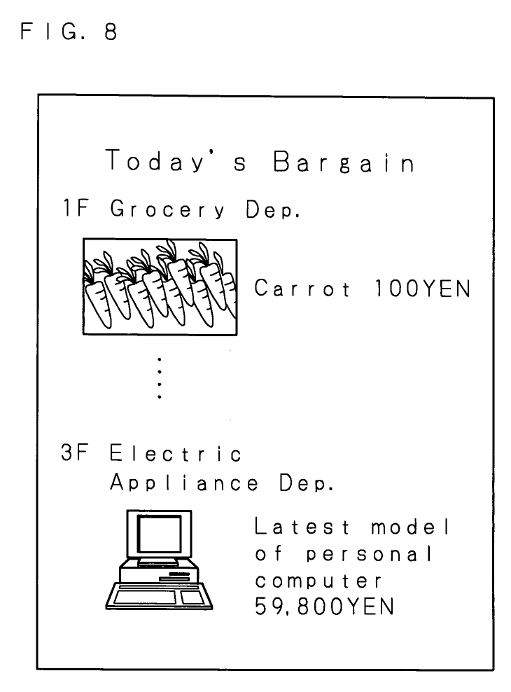

FIG. 7A to FIG. 7H are flowcharts showing procedure executed by the information providing system according to Embodiment 1 of the present invention, and FIG. 8 is a schematic view showing an example of a display screen of provision information by the browsing program executed by the terminal apparatus 30 serving as one component of the information providing system according to the present invention.

The control unit 36 of the terminal apparatus 30 transmits the terminal identifying information for identifying the terminal apparatus 30 to the relay apparatus 20 through the communication unit 31 (S101).

The control unit 24 of the relay apparatus 20 is in a stand-by state until it receives the terminal identifying information transmitted from the terminal apparatus 30 through the second communication unit 22 (No at S102). When it is judged that the terminal identifying information is received from the terminal apparatus 30 (YES at S102), the control unit 24 registers the received terminal identifying information in the relay table 231 and transmits it to the central unit 10 through the first communication unit 21 (S103 and S104).

The control unit 17 of the central apparatus 10 is in a stand-by state until it receives through the communication unit 15 the terminal identifying information transmitted from the relay apparatus 20 (NO at S105). When it is judged that the terminal identifying information is received from the relay apparatus 20 (YES at S105), the control unit 17 registers the received terminal identifying information in the program management table 101 and reads out the confirmation notice display data from the hard disk 14 and transmits it to the relay apparatus 20 through the communication unit 15 (S106 and S107).

The control unit 24 of the relay apparatus 20 receives the confirmation notice display data transmitted from the central apparatus 10 through the first communication unit 21 (S108). The control unit 24 transmits the received confirmation notice display data to the terminal apparatus 30 identified by the terminal identifying information previously registered in the relay table 231 through the second communication unit 22 (S109).

The control unit 36 of the terminal apparatus 30 receives the confirmation notice display data transmitted from the relay apparatus 20 through the communication unit 31 (S110). The control unit 36 makes the output unit 33 output (display) the confirmation notice based on the received confirmation notice display data (S111). When the user inputs through the input unit 34 the response to the confirmation notice displayed in the output unit 33, the control unit 36 accepts the response (S112), and transmits the accepted response to the relay apparatus 20 through the communication unit 31 (S113).

The control unit 24 of the relay apparatus 20 receives the response transmitted from the terminal apparatus 30 through the second communication unit 22 (S114). The control unit 24 transmits the received response to the central apparatus 10 through the first communication unit 21 (S115).

The control unit 17 of the central apparatus 10 receives the response transmitted from the relay apparatus 20 through the communication unit 15 (S116). The control unit 17 reads out the browsing program 14a from the hard disk 14 in response to the received response (S117) and transmits the read browsing program 14a to the relay apparatus 20 through the communication unit 15 (S118).

The control unit 24 of the relay apparatus 20 receives the browsing program 14a transmitted from the central apparatus 10 through the first communication unit 21 (S119). The control unit 24 transmits the received browsing program 14a to the terminal apparatus 30 identified by the terminal identifying information previously registered in the relay table 231 through the second communication unit 22 (S120).

The control unit 36 of the terminal apparatus 30 receives the browsing program 14a transmitted from the relay apparatus 20 through the communication unit 31 (S121), and stores the received browsing program 14a in the RAM 32 (S122). Then, the control unit 36 makes the output unit 33 output (display) a screen for accepting a start of the browsing program 14a stored in the RAM 32 (S123). When an instruction to start the browsing program 14a by the user is accepted (S124), the control unit 36 starts the browsing program 14a in response to the accepted start instruction (S125), and generates a start notice for notifying that the browsing program 14a is started (S126). The generated start notice is transmitted by the control unit 36 to the relay apparatus 20 through the communication unit 31 (S127). Note that, after the browsing program 14a is started, the control unit 36 continues to transmit the start notice at intervals of one second, for example, as long as the browsing program 14a is in operation.

Therefore, even when the user of the terminal apparatus 30 enters the communicable range of the relay apparatus 20, the user is not unilaterally forced to receive the provision information as long as the user does not input a start instruction of the browsing program 14a.

The control unit 24 of the relay apparatus 20 receives the start notice transmitted from the terminal apparatus 30 through the second communication unit 22 (S128). The control unit 24 transmits, together with the received start notice, the relay apparatus identifying information read from the storage unit 23 to the central apparatus 10 through the first communication unit 21 (S129).

The control unit 17 of the central apparatus 10 receives the start notice and the relay apparatus identifying information transmitted from the relay apparatus 20 through the communication unit 15 (S130). The control unit 17 registers dominical year, month, date, hour, minute and second of the time of receiving the start notice based on the time clocked by the timer unit 18 when the start notice is received, and the received relay apparatus identifying information in a corresponding record (a record corresponding to the terminal identifying information previously registered in the program management table 101 at step S106) in the program management table 101 (S131). Further, the control unit 17 reads out the information ID corresponding to the registered relay apparatus identifying information from the communication table 104 (S132), and obtains a transmittable time by reading out the transmission start time, the transmission end time and the transmission cycle corresponding to the read information ID from the information management table 103 (S133). Then, the control unit 17 judges whether the start notice receipt time coincides with the obtained transmittable time or not (S134). When it is judged that they do not coincide with each other (NO at S134), the control unit 17 returns to the previous processing of step S130 and waits for receiving a next start notice. Therefore, in this case, at step S134 described below, when the start notice receipt time coincides with the obtained transmittable time, the processing proceeds to following S135.

Although not shown in the flowcharts in FIG. 7A to FIG. 7H, when the user of the terminal apparatus 30 terminates the browsing program 14a, when the terminal apparatus 30 is apart from the transmittable range of the relay apparatus 20, or the like, the control unit 17 of the central apparatus 10 does not receive the start notice and the terminal identifying information from the relay apparatus 20 at step S130 (NO at S130). In this case, the control unit 17 of the central apparatus 10 terminates the processing.

When it is judged that the start notice receipt time and the transmittable time coincide with each other (YES at S134), the control unit 17 reads the value of the distribution flag of the corresponding record in the information management table 103 and judges whether the value is “0” or not (S135). When it is judged that the distribution flag is “0” (YES at S135), the control unit 17 terminates the processing. Meanwhile, when it is judged that the distribution flag is not “0” (NO at S135), the control unit 17 further judges whether the distribution flag is “1” or not (S136). When it is judged that the distribution flag is “1” (YES at S136), the control unit 17 extracts from the information management table 103 provision information corresponding to the information ID previously read out (S137), and transmits the extracted provision information through the communication unit 15 to the relay apparatus 20 identified by the relay apparatus identifying information previously received (S138). When it is judged that the distribution flag is not “1” (that is, when it is “2”) (NO at S136), the control unit 17 extracts from the information management table 103 provision information corresponding to the information ID previously read out (S139), adds an authentication screen to the extracted provision information (S140), and proceeds the process to step S138. In this case, the provision information to which the authentication screen is added is transmitted.

The control unit 24 of the relay apparatus 20 receives the provision information transmitted from the central apparatus 10 through the first communication unit 21 (S141), and transmits the received provision information to the terminal apparatus 30 identified by the terminal identifying information through the second communication unit 22 (S142).

The control unit 36 of the terminal apparatus 30 receives the provision information transmitted from the relay apparatus 20 through the communication unit 31 (S143), and judges whether an authentication screen is added to the received provision information or not (S144). When it is judged that the authentication screen is added (YES at S144), the control unit 36 makes the output unit 33 output (display) the authentication screen added to the received provision information (S145). When the user operates the input unit 34 to input the member ID and the member password on the authentication screen displayed in the output unit 33, the control unit 36 accepted them (S146). The control unit 36 transmits the member ID and member password thus accepted to the relay apparatus 20 together with the terminal identifying information (S147).

The control unit 24 of the relay apparatus 20 receives the member ID, the member password and the terminal identifying information transmitted from the terminal apparatus 30 through the second communication unit 22 (S148), and transmits the received member ID, the member password and the terminal identifying information to the central apparatus 10 through the first communication unit 21 (S149).

The control unit 17 of the central apparatus 10 receives the member ID, the member password and the terminal identifying information transmitted from the relay apparatus 20 through the communication unit 15 (S150). Then, the control unit 17 performs a member authentication process of judging whether the received member ID and the member password are registered in the member information table 102 or not (S151). This authentication process itself is a well-known technique. When the member is not authenticated (NO at S151), the control unit 17 terminates the processing. In this case, provision information is not displayed in the terminal apparatus 30. When the member is authenticated (YES at S151), the control unit 17 registers the received terminal identifying information in a corresponding record in the member information table 102 (S152), and transmits a browsing permission to the relay apparatus 20 through the communication unit 15 (S153).

The control unit 24 of the relay apparatus 20 receives the browsing permission transmitted from the central apparatus 10 through the first communication unit 21 (S154), and transmits the received browsing permission to the terminal apparatus 30 identified by the terminal identifying information through the second communication unit 22 (S155).

The control unit 36 of the terminal apparatus 30 receives the browsing permission transmitted from the relay apparatus 20 through the communication unit 31 (S156). When the control unit 36 thus receives the browsing permission, the control unit 36 makes the output unit 33 output (display) the provision information received at step S143, as shown in FIG. 8 (S157). The displayed provision information is high-value added information in the vicinity of the relay apparatus 20 installed, such as “1F Grocery Department, Carrot 100 yen” or “3F Electric Appliance Department, Latest model of personal computer 59,800 yen”.

Meanwhile, when the control unit 36 of the terminal apparatus 30 judges that the authentication screen is not added at step S144 (NO at S144), it makes the output unit 33 output (display) the provision information received at step S143 as it is as shown in FIG. 8 (S157).

### Embodiment 2

According to Embodiment 2, a description will be made of a function in which a terminal apparatus 30 can select a relay apparatus 20 that relays provision information having the most highest value added at the present position and receive the provision information through the selected relay apparatus 20 when each of the plurality of relay apparatuses 20 has different provision information to be transmitted, as in one example of the registered contents of the communication table 104 shown in FIG. 5, in addition to the above-described Embodiment 1.

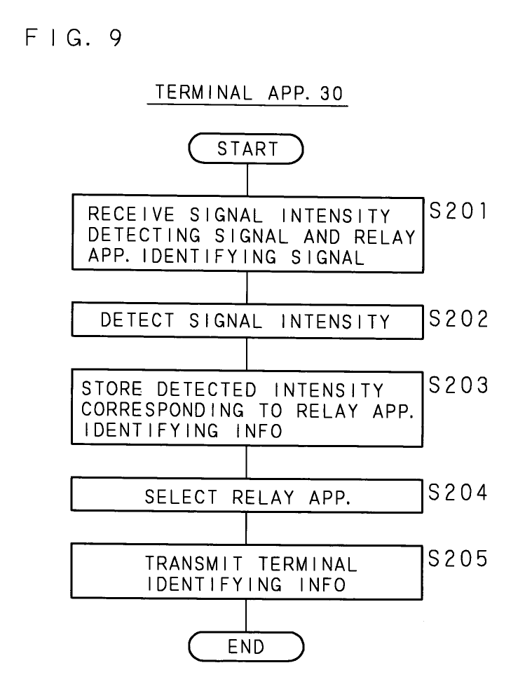

FIG. 9 is a flowchart showing a procedure in the terminal apparatus in the information providing system according to the Embodiment 2 of the present invention.

As described above, each of the plurality of relay apparatuses 20 transmits a signal intensity detecting signal for detecting a signal intensity in wireless communication between the relay apparatus 20 and the terminal apparatus 30, and relay apparatus identifying information read from a storage unit 23, to the terminal apparatus 30 through a second communication unit 22.

A control unit 36 of the terminal apparatus 30 receives the signal intensity detecting signal and the relay apparatus identifying information respectively transmitted from the plurality of relay apparatuses 20 through a communication unit 31 (S201), detects the intensity of the received signal intensity detecting signal (S202), and stores the detected intensity in a RAM 32 so as to be corresponding to the relay apparatus identifying information (S203).

The control unit 36 selects the relay apparatus 20 identified by the relay apparatus identifying information corresponding to the signal intensity detection signal having the highest signal intensity among the signal intensities stored in the RAM 32 (S204). Then, the control unit 36 transmits the relay apparatus identifying information for identifying the selected relay apparatus 20 and terminal identifying information for identifying the terminal apparatus 30 in which the control unit 36 itself is provided through the communication unit 31 (S205).

As a result, the terminal apparatus 30 can communicate only with the relay apparatus 20 which outputs the signal intensity detection signal having the highest signal intensity at the present position, that is, the relay apparatus 20 which exists at the nearest position from the terminal apparatus 30. Therefore, the terminal apparatus 30 can receive the provision information having the highest value added at the present position from the relay apparatus 20.

In Embodiment 2, the above-described process is executed, while the other processes are the same as those executed in Embodiment 1. Therefore, the same reference numerals are given to the corresponding components and the description will not be repeated.

According to the above-described Embodiment 2, there has been shown a case where the terminal apparatus 30 receives the signal from the relay apparatus 20 and selects the relay apparatus 20 that relays the provision information having the highest value added at the present position. However, the present invention is not limited to this case and procedure may be such that the communication with the relay apparatus 20 is stopped when the terminal apparatus 30 cannot receive any signal from any of the relay apparatuses 20, and the browsing program 14a is deleted when the browsing program 14a is stored in the RAM 32. According to such procedure, when the user of the terminal apparatus 30 is out of the communicable ranges of all relay apparatuses 20, the browsing program 14a is automatically deleted. As a result, after the user of the terminal apparatus 30 leaves the communicable ranges of all relay apparatuses 20, even when the user enters the communicable range of any of the relay apparatuses 20 again, the browsing program 14a is prevented from being doubly received and started.

### Embodiment 3

According to Embodiment 3, a description will be made of a function in which, when there are a plurality of terminal apparatuses 30 that can communicate with a relay apparatus 20, one terminal apparatus can request transmission of position information of another terminal apparatus (or the one terminal apparatus itself) in addition to Embodiments 1 and 2.

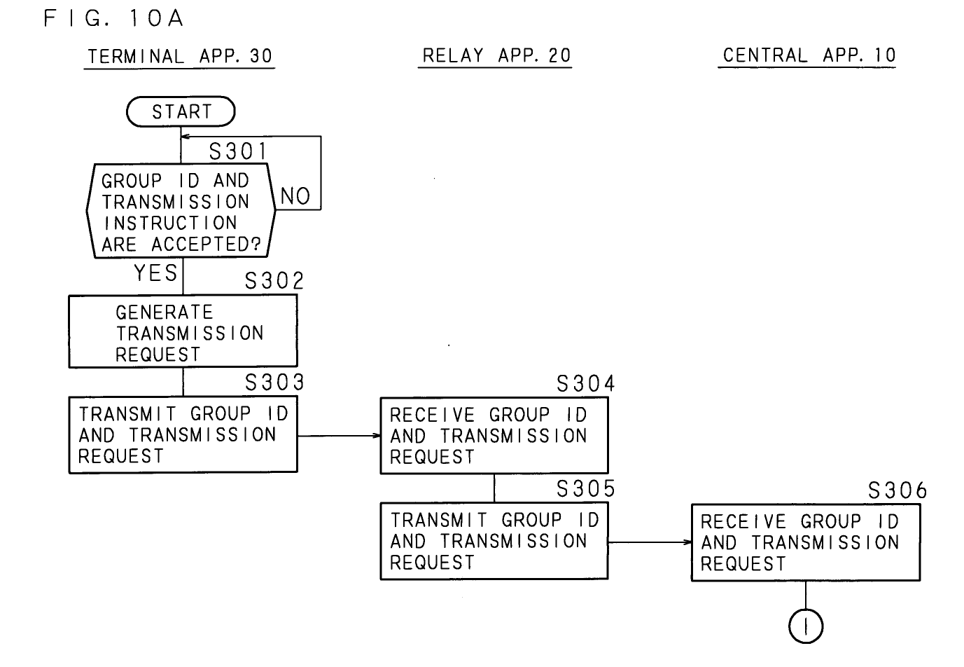

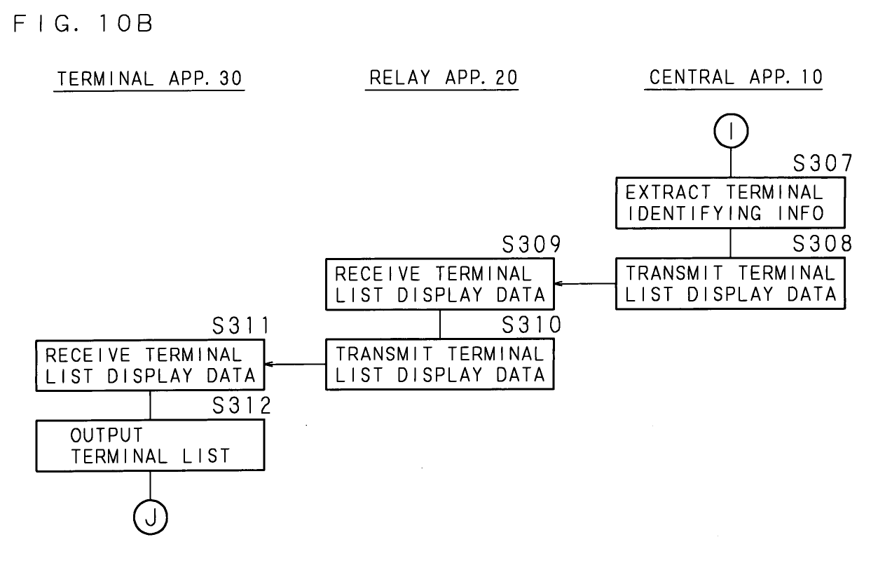

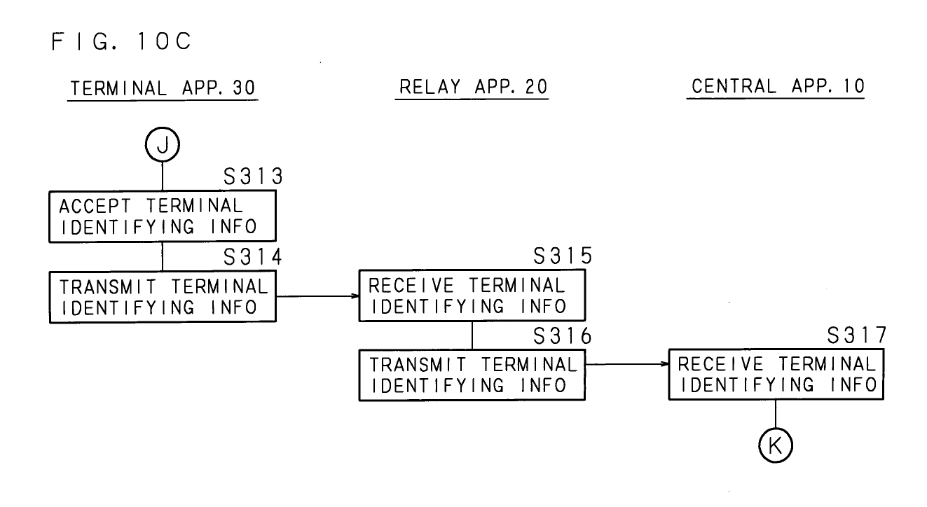

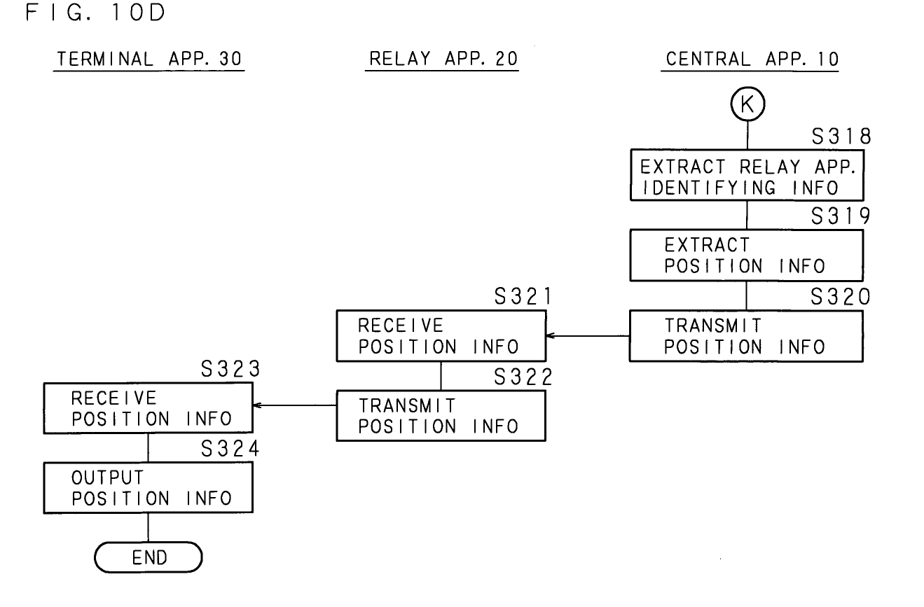

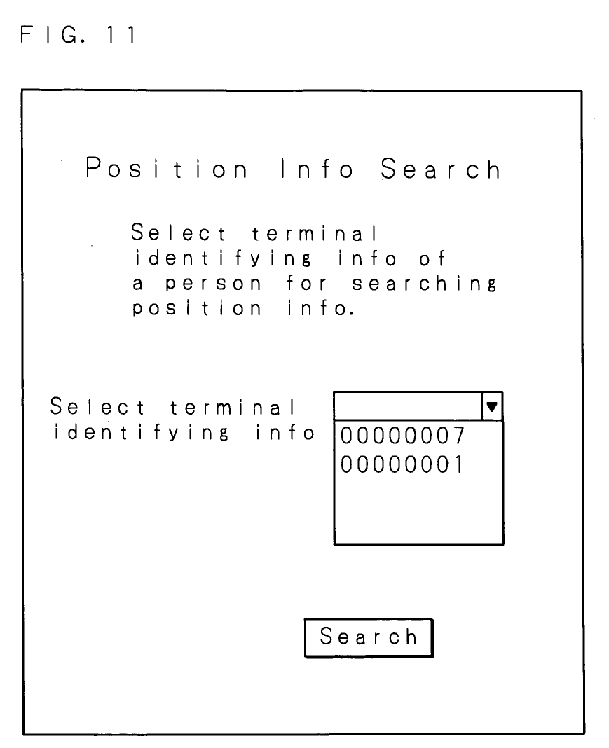

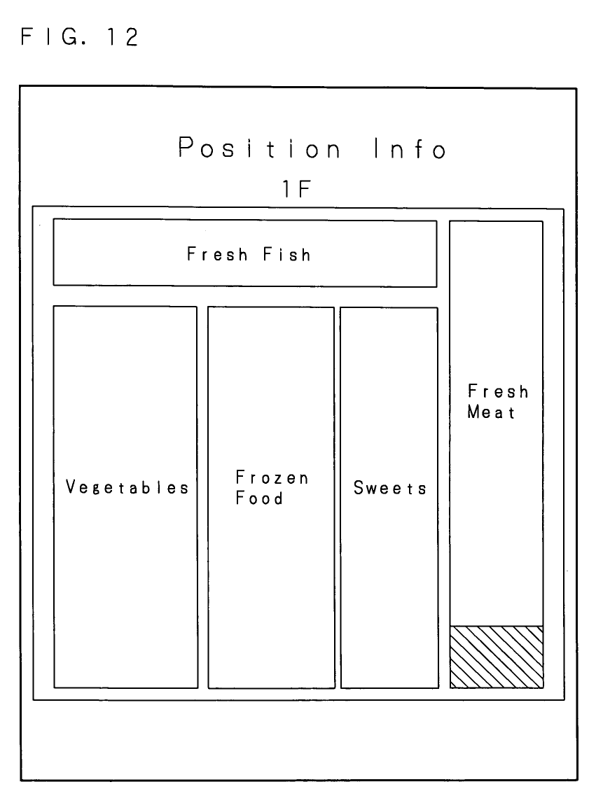

FIG. 10A to FIG. 10D are flowcharts showing a procedure of the Embodiment 3 according to the information providing system of the present invention, FIG. 11 is a schematic view showing a display example of a screen for receiving terminal identifying information by a browsing program executed in the terminal apparatus 30 serving as one component of the information providing system according to the present invention, and FIG. 12 is a schematic view showing a display example of a screen for displaying the position information by the browsing program executed in the terminal apparatus 30 serving as one component of the information providing system according to the present invention.

The user of the terminal apparatus 30 inputs his or her group ID and then inputs a transmission instruction on a screen displayed in the output unit 33 when a control unit 36 executes the already started browsing program 14a.

The control unit 36 of the terminal apparatus 30 waits for acceptance of the group ID and the transmission instruction (NO at S301). When it is judged that the group ID and the transmission instruction are accepted (YES at S301), the control unit 36 generates a transmission request based on the accepted transmission instruction (S302), and transmits the group ID and the generated transmission request to the relay apparatus 20 through a communication unit 31 (S303).

A control unit 24 of the relay apparatus 20 receives the group ID and the transmission request transmitted from the terminal apparatus 30 through a second communication unit 22 (S304). The control unit 24 transmits the received group ID and the transmission request to the central apparatus 10 through a first communication unit 21 (S305).

A control unit 17 of the central apparatus 10 receives the group ID and the transmission request transmitted from the relay apparatus 20 through a communication unit 15 (S306). The control unit 17 extracts from a member information table 102 terminal identifying information corresponding to the received group ID in response to the received transmission request (S307), and transmits data (hereinafter referred to as the terminal list display data) for displaying a list of the extracted terminal identifying information (hereinafter referred to as the terminal list) to the relay apparatus 20 through the communication unit 15 (S308).

The control unit 24 of the relay apparatus 20 receives the terminal list display data transmitted from the central apparatus 10 through a first communication unit 21 (S309), and transmits the received terminal list display data to the terminal apparatus 30 through the second communication unit 22 (S310).

The control unit 36 of the terminal apparatus 30 receives the terminal list display data transmitted from the relay apparatus 20 (S311), and makes the output unit 33 output (display) the terminal list based on the received terminal list display data as shown in FIG. 11 (S312). When the user operates the input unit 34 to select certain terminal identifying information from the terminal list displayed in the output unit 33, the control unit 36 receives the selected terminal identifying information (S313), and transmits the accepted terminal identifying information to the relay apparatus 20 through the communication unit 31 (S314). The terminal list displayed on the output unit 33 displays the list of terminal identifying information by a pull-down menu as shown in FIG. 11. The user of the terminal apparatus 30 selects the terminal identifying information to be searched target from the terminal list and presses a “search” button so that the user can input the terminal identifying information of which the present position is to be searched.

The control unit 24 of the relay apparatus 20 receives the terminal identifying information transmitted from the terminal apparatus 30 through the second communication unit 22 (S315), and transmits the received terminal identifying information to the central apparatus 10 through the first communication unit 21 (S316).

The control unit 17 of the central apparatus 10 receives the terminal identifying information transmitted from the relay apparatus 20 (S317), and extracts from a program management table 101 relay apparatus identifying information of the relay apparatus 20 which communicates with the terminal apparatus 30 identified by the received terminal identifying information (S318). The control unit 17 extracts from the program management table 101 position information corresponding to the extracted relay apparatus identifying information (position on map information at which the relay apparatus 20 identified by the extracted relay apparatus identifying information is installed) (S319), and transmits the extracted position information to the relay apparatus 20 which transmitted the terminal identifying information received at step S317 (S320).

The control unit 24 of the relay apparatus 20 which transmitted the terminal identifying information to the central apparatus 10 at step S316 receives the position information transmitted from the central apparatus 10 through the first communication unit 21 (S321), and transmits the received position information to the terminal apparatus 30 through the second communication unit 22 (S322).

The control unit 36 of the terminal apparatus 30 receives the position information transmitted from the relay apparatus 20 (S323), and makes the output unit 33 output (display) the received position information as shown in FIG. 12 (S324). According to the received position information, the position corresponding to the searched result on the map image is enhanced by reversing display, for example, as shown in FIG. 12. note that, the position information may be displayed in a form of character information, or may be outputted in a form of audio information.

As a result, the user of the terminal apparatus 30 can confirm a position of another user who is a family member or a friend on the screen displayed in the output unit 33. In the above-described Embodiment 3, the user to be searched is selected from the list (terminal list) of the terminal identifying information. However, the present invention is not limited to this case and the user to be searched may be selected from a list generated based on the member IDs in the member information table 102.

When realistic titles such as “mother”, “father” and the like are registered corresponding to the terminal identifying information, the title such as the “mother” or “father”, instead of the terminal identifying information, may be displayed in the terminal list in the terminal apparatus 30.

In each Embodiment above-described, an example is shown in which the terminal apparatus 30 receives one piece of provision information from each relay apparatus 20. However, the present invention is not limited to this case. When each relay apparatus 20 relays a plurality of pieces of provision information, the user may designate a desired piece of provision information to be received from the plurality of pieces of provision information. For example, the user of the terminal apparatus 30 starts the browsing program 14a and then performs an operation to designate the desired provision information to be received from the plurality of pieces of provision information. In response, the control unit 36 of the terminal apparatus 30 generates provision information specifying information for specifying the provision information designated by the user, and transmits the generated provision information specifying information to the central apparatus 10 through the relay apparatus 20.

The control unit 17 of the central apparatus 10 extracts from an information management table 103 provision information specified by the provision information specifying information received through the relay apparatus 20, and transmits the extracted provision information to the terminal apparatus 30 through the relay apparatus 20.

The control unit 36 of the terminal apparatus 30 transmits the provision information received through the relay apparatus 20 to the output unit 33 to be displayed by the browsing program 14a. As a result, since the user of the terminal apparatus 30 can receive only the information of which value added is regarded by the user as especially high among the plurality of pieces of provision information, the user is not unilaterally forced to receive unnecessary provision information.

In each Embodiment above described, the control unit 36 of the terminal apparatus 30 transmits the received provision information to the output unit 33 to be displayed by the browsing program 14a. However, the present invention is not limited to this case, and the provision information may be stored in the RAM 13 as history information. In such a case, the user of the terminal apparatus 30 can confirm the past record even when the user fails to browse the information having high value added. The provision information may be displayed in a form of an image, outputted in a form of audio information, or both may be used together.

In each Embodiment above described, an example is shown in which the database 100 is an apparatus provided separately from the central apparatus 10. However, the present invention is not limited to this case, and the database 100 may be constructed in the hard disk 14 of the central apparatus 10. Alternatively, the database 100 may be connected to the central apparatus 10 through the network NW.

As this invention may be embodied in several forms without departing from the sprit of essential characteristics thereof, the present Embodiments are therefore illustrative and not restrictive, since the scope of the invention is defined by the appended claims rather than by the description preceding them, and all changes that fall within metes and bounds of the claims, or equivalence of such metes and bounds there-of are therefore intended to be embraced by the claims.

What is claimed is:

1. An information providing method for providing provision information from a central apparatus to a terminal apparatus through a relay apparatus, said central apparatus being connected to a database in which provision information is registered and having a storage unit in which a browsing program for browsing the provision information is stored, and said terminal apparatus having a storage unit, comprising the steps of:
by said central apparatus, reading said browsing program from said storage unit;
by said central apparatus; transmitting said read browsing program to said relay apparatus;
by said relay apparatus, transmitting said browsing program received from said central apparatus to said terminal apparatus;
by said terminal apparatus, storing said browsing program received from said relay apparatus in said storage unit;
by said terminal apparatus, accepting a start instruction of said browsing program stored in said storage unit;
by said terminal apparatus, starting said browsing program stored in said storage unit according to said accepted start instruction;
by said terminal apparatus, transmitting a start notice for notifying that said browsing program is started to said relay apparatus;
by said relay apparatus, transmitting said start notice received from said terminal apparatus to said central apparatus; and
by said central apparatus, when said start notice is received from said relay apparatus, extracting said provision information from said database in response to said start notice received from said relay apparatus and transmitting to said terminal apparatus through said relay apparatus.

2. An information providing system including:
a database in which provision information is registered;
a central apparatus, having a storage unit in which a browsing program for browsing the provision information is stored, for transmitting the provision information extracted from said database;
a relay apparatus, capable of communicating with said central apparatus and said terminal apparatus, for relaying the provision information received from said central apparatus to said terminal apparatus; and
a terminal apparatus, capable of communicating with said relay apparatus, for receiving the provision information relayed by said relay apparatus;
wherein
said central apparatus comprises means for transmitting said browsing program read from said storage unit to said relay apparatus;
said relay apparatus comprises means for transmitting said browsing program received from said central apparatus to said terminal apparatus,
said terminal apparatus comprises: receiving means for receiving said browsing program from said relay apparatus; storing means for storing said received browsing program; means for accepting a start instruction of said browsing program stored in said storing means; means for staring the browsing program stored in said storing means according to the accepted start instruction; and notice transmitting means for transmitting a start notice for notifying that said browsing program is started to said relay apparatus;
said relay apparatus transmits the start notice received from said terminal apparatus to said central apparatus, and
said central apparatus, when said start notice is received from said relay apparatus, extracts said provision information from said database in response to said start notice received from said relay apparatus and transmits to said terminal apparatus through said relay apparatus.

3. The information providing system as set forth in claim 2, wherein
a plurality of said relay apparatuses are provided, and relay apparatus identifying information for identifying each relay apparatus is assigned to each relay apparatus,
a plurality of said terminal apparatuses are provided, and terminal identifying information for identifying each terminal apparatus is assigned to each terminal apparatus,
a plurality of pieces of provision information are registered in said database so as to correspond to the relay apparatus identifying information for identifying each of said plurality of relay apparatuses,
said each terminal apparatus transmits said start notice to said relay apparatus together with the terminal identifying information for identifying said each terminal apparatus,
said each relay apparatus transmits the received start notice to said central apparatus together with the relay apparatus identifying information for identifying said each relay apparatus, and
said central apparatus, when the start notice and the relay apparatus identifying information are received from said relay apparatus, extracts from said database provision information registered so as to correspond to the received relay apparatus identifying information in response to the received start notice, and transmits the extracted provision information to the relay apparatus identified by the received relay apparatus identifying information.

4. The information providing system as set forth in claim 3, wherein
communication between said each relay apparatus and said each terminal apparatus is performed by wireless communication,
said each relay apparatus further comprises means for transmitting a signal for detecting a signal intensity in said wireless communication to said terminal apparatus so as to correspond to said relay apparatus identifying information,
said each terminal apparatus further comprises means for detecting an intensity of the received signal, and means for selecting a relay apparatus identified by the relay apparatus identifying information corresponding to a signal having a highest intensity among the detected intensities, and makes said notice transmitting means transmit the start notice to said selected relay apparatus.

5. The information providing system as set forth in claim 4, wherein
said terminal apparatus comprises means for, by control of said browsing program, generating provision information specifying information for specifying the provision information to which specifying is accepted, when said terminal apparatus accepts specifying of one of said plurality of pieces of provision information,
said notice transmitting means transmits said start notice to said relay apparatus together with said generated provision information specifying information, and
said central apparatus extracts from said database provision information corresponding to the received relay apparatus identifying information and provision information specifying information in response to the received start notice, when said central apparatus receives said start notice, the provision information specifying information and the relay apparatus identifying information from said relay apparatus.

6. The information providing system as set forth in claim 5, further including a database in which said terminal identifying information for identifying the terminal apparatus having transmitted the start notice, said relay apparatus identifying information, and said position information regarding a position of the relay apparatus installed identified by the relay apparatus identifying information are correspondingly registered,
wherein
said terminal apparatus further comprises: means for, by control of said browsing program, generating a transmission request based on the accepted transmission instruction when a transmission instruction of said position information is accepted; means for receiving the terminal identifying information for identifying the terminal apparatus of which position information is to be searched and the transmission instruction of the position information; means for transmitting the generated transmission request and the accepted terminal identifying information to said central apparatus through said relay apparatus; and output means for, by control of said browsing program, outputting the received information;
said central apparatus further comprises: means for extracting from said database the position information corresponding to the received terminal identifying information in response to the received transmission request; and means for transmitting the extracted position information to said terminal apparatus through said relay apparatus,
wherein said terminal apparatus makes, by control of said browsing program, said output means output the received position information.

7. An information providing apparatus which is connected to a database in which provision information and identifying information for identifying an external apparatus to which the provision information is to be transmitted are correspondingly registered, and transmits the provision information registered in said database to an external apparatus, comprising:
a storage unit in which a browsing program for browsing the provision information is stored;
means for reading said browsing program from said storage unit when the identifying information is received from an external apparatus;
means for transmitting said read browsing program to the external apparatus identified by said received identifying information;
means for, when from an external apparatus a start notice for notifying that said browsing program is started and identifying information for identifying the external apparatus are received, in response to the received start notice, extracting the provision information corresponding to the received identifying information from said database; and
means for transmitting the extracted provision information to the external apparatus identified by said received identifying information.

8. An information providing apparatus which is connected to a database in which provision information and identifying information for identifying an external apparatus to which the provision information is to be transmitted are correspondingly registered, comprises a communication unit capable of communication with an external apparatus, and transmits the provision information registered in said database to an external apparatus by said communication unit, comprising:
a storage unit in which a browsing program for browsing the provision information is stored;
a controller, connected with said database, said storage unit and said communication unit, capable of performing the following operations of:
reading said browsing program from said storage unit when the identifying information is received from an external apparatus;
transmitting said read browsing program to the external apparatus identified by said received identifying information by said communication unit;
when by said communication unit receives from an external apparatus a start notice for notifying that said browsing program is started and identifying information for identifying said external apparatus, in response to the received start notice, extracting the provision information corresponding to the received identifying information from said database; and
transmitting the extracted provision information to the external apparatus identified by said received identifying information by said communication unit.

9. An information receiving apparatus for receiving the provision information from an information providing apparatus, said information providing apparatus being connected to a database in which provision information is registered, and transmitting the provision information registered in said database and a browsing program for browsing the provision information to outside, comprising:
storing means for storing said browsing program transmitted from said information providing apparatus;
means for accepting a start instruction of the browsing program stored in said storing means;
means for starting the browsing program stored in said storing means according to the accepted start instruction;
notice transmitting means for transmitting to said information providing apparatus a start notice for notifying that said browsing program is started;
means for receiving the provision information which is, by said information provision apparatus, extracted from said database and transmitted in response to a received start notice when said information providing apparatus receives the start notice; and
outputting means for, by control of said browsing program, outputting the received provision information.

10. The information receiving apparatus as set forth in claim 9, further comprising:
communicating means for communicating with said information providing apparatus by wireless communication through one of the plurality of relay apparatuses to which relay apparatus identifying information for identifying each relay apparatus is assigned;
means for detecting an intensity of a signal received from each relay apparatus by wireless communication; and
means for selecting the relay apparatus identified by the relay apparatus identifying information corresponding to a signal having a highest intensity among the detected intensities;
wherein said communicating means communicates with said information providing apparatus through said selected relay apparatus.

11. The information receiving apparatus as set forth in claim 10, further comprising:
means for accepting specifying of one of said plurality of pieces of provision information; and
means for, by control of said browsing program, generating provision information specifying information for specifying the specified provision information to which specifying is accepted;
wherein
said notice transmitting means transmits said start notice to said information providing apparatus through said relay apparatus together with said generated provision information specifying information,
said communicating means receives through said relay apparatus the provision information extracted from said database by said information providing apparatus, when said information providing apparatus receives said start notice, said provision information specifying information and said relay apparatus identifying information, in response to the received start notice, correspondingly to the received relay apparatus identifying information and the provision information specifying information, and
said outputting means outputs said received provision information by control of said browsing program.

12. The information receiving apparatus as set forth in claim 11, further comprising:
means for, by control of said browsing program, generating a transmission request, when a transmission instruction of said position information is accepted, based on the accepted transmission instruction;
means for accepting the identifying information for identifying the external apparatus of which position information is to be searched and the transmission instruction of the position information; and
means for transmitting the generated transmission request and the accepted identifying information to said information providing apparatus through said relay apparatus,
wherein
said communicating means receives the position information extracted by said information providing apparatus in response to the received transmission request, corresponding to the identifying information received by said information providing apparatus, from a data base correspondingly; registering the identifying information for identifying the external apparatus having transmitted said start notice, said relay apparatus identifying information and said position information on a position of the relay apparatus installed identified by said relay apparatus identifying information, and
said outputting means outputs said received position information by control of said browsing program.

13. An information receiving apparatus for receiving the provision information from an information providing apparatus, said information providing apparatus being connected to a database in which provision information is registered, and transmitting the provision information registered in said database and a browsing program for browsing the provision information to outside, comprising:
a storage unit for storing said browsing program transmitted from said information providing apparatus;
a input unit for accepting a start instruction of the browsing program stored in said storage unit;
a communication unit capable of communicating with said information providing apparatus; and
a controller, connected with said storage unit, said input unit, said output unit, and said input unit, capable of performing the following operations of:
starting the browsing program stored in said storage unit according to the accepted start instruction accepted by said input unit;
transmitting by said communication unit to said information providing apparatus a start notice for notifying that said browsing program is started;
receiving by said communication unit the provision information which is, by said information provision apparatus, extracted from said database and transmitted in response to a received start notice when said information providing apparatus receives the start notice; and
outputting the received provision information to said output unit by control of said browsing program.

14. The information receiving apparatus as set forth in claim 13, wherein
said controller further capable of performing the following operations of:
communicating by said information providing apparatus by wireless communication through one of the plurality of relay apparatuses to which relay apparatus identifying information for identifying each relay apparatus is assigned;
detecting an intensity of a signal received from each relay apparatus by wireless communication;
selecting the relay apparatus identified by the relay apparatus identifying information corresponding to a signal having a highest intensity among the detected intensities; and
communicating by said communication unit with said information providing apparatus through said selected relay apparatus.

15. The information receiving apparatus as set forth in claim 14, wherein
said controller further capable of performing the following operations of:
accepting by said input unit specifying of one of said plurality of pieces of provision information;
by control of said browsing program, generating provision information specifying information for specifying the specified provision information to which specifying is accepted;
transmitting by said communication unit said start notice to said information providing apparatus through said relay apparatus together with said generated provision information specifying information;
receiving by said communication unit through said relay apparatus the provision information extracted from said database by said information providing apparatus, when said information providing apparatus receives said start notice, said provision information specifying information and said relay apparatus identifying information, in response to the received start notice, correspondingly to the received relay apparatus identifying information and the provision information specifying information; and
outputting said received provision information by control of said browsing program.

16. The information receiving apparatus as set forth in claim 15, wherein
said processor further capable of the following operations of:
by control of said browsing program, generating a transmission request, when a transmission instruction of said position information is accepted, based on the accepted transmission instruction;
accepting by said input unit the identifying information for identifying the external apparatus of which position information is to be searched and the transmission instruction of the position information;
transmitting by said communication unit the generated transmission request and the accepted identifying information to said information providing apparatus through said relay apparatus;
receiving by said communication unit the position information extracted by said information providing apparatus in response to the received transmission request, corresponding to the identifying information received by said information providing apparatus, from a data base correspondingly registering the identifying information for identifying the external apparatus having transmitted said start notice, said relay apparatus identifying information and said position information on a position of the relay apparatus installed identified by said relay apparatus identifying information; and
outputting said received position information to said output unit by control of said browsing program.

17. A computer program product for controlling a computer connected to a database in which provision information and identifying information indicating an external apparatus to which the provision information is to be provided are correspondingly registered and having a storage unit in which a browsing program for browsing the provision information is stored, for transmitting the provision information registered in said database to outside, wherein the computer program product comprises:
a computer readable storage medium having computer readable program code means embodied in said medium, said computer readable program code means comprising computer instruction means for:
reading said browsing program from said storage unit;
transmitting said read browsing program to outside;
receiving from an external apparatus a start notice for notifying that said browsing program is started and identifying information for identifying said external apparatus;
extracting from said database the provision information corresponding to the received identifying information in response to said received start notice; and
transmitting the extracted provision information to said external apparatus identified by the received identifying information.
